(19) United States
(12) Patent Application Publication
(10) Pub. No.: US 2025/0373451 A1
(43) Pub. Date: Dec. 4, 2025

(54) TRUST-ENABLED ARTIFICIAL INTELLIGENCE AND NON-HUMAN IDENTITY ORCHESTRATOR FRAMEWORK

(71) Applicant: Operant Networks, Santa Rosa, CA (US)

(72) Inventors: Roger L. JUNGERMAN, Petaluma, CA (US); Randall KING, Santa Rosa, CA (US)

(21) Appl. No.: 19/214,436

(22) Filed: May 21, 2025

Related U.S. Application Data
(60) Provisional application No. 63/653,178, filed on May 29, 2024.

(51) Int. Cl. H04L 9/32; H04L 9/08

(52) U.S. Cl. CPC H04L 9/3268; H04L 9/0825; H04L 9/3234; H04L 9/3247

(57) ABSTRACT

Described herein are techniques for secure orchestration and publication control among agents (e.g., distributed agents), such as non-human identities (NHI), using cryptographic certificates, trust rules, and/or an Information-Centric Networking (ICN) architecture. In an example, a framework establishes identity for human and non-human identities-such as AI agents, services, and autonomous workloads—via cryptographically signed publications and/or collections. Trust policies can be defined and enforced through signed, verifiable trust rules, enabling access control, provenance validation, and/or policy delegation across federated domains. The disclosed techniques can enable multi-agent systems (MAS), zero-trust enforcement, and/or secure cross-domain communication using ICN-named role-based certificates and programmable trust shims. The disclosed techniques can also enable decentralized validation and selective replication of data while maintaining traceability and fine-grained control of agent behavior.

### CROSS-REFERENCE TO RELATED APPLICATION(S)

This application claims the benefit of priority to U.S. Provisional Patent Application No. 63/653, 178, filed on May 29, 2024, and titled “Trust Enabled AI Orchestrator Framework,” the disclosure of which is incorporated by reference in its entirety and for all purposes.

### TECHNICAL FIELD

The present technology is directed generally to identity management and orchestration of artificial intelligence (AI) agents and other non-human identities (NHI) in distributed computing environments. In some aspects, the present disclosure relates to trust-enabled frameworks for managing roles, actions, and/or communications among autonomous agents, subsystems, infrastructure components and/or services, such as for secure delegation, verification, and/or coordination of machine-originated or machine-facilitated decisions and/or activities.

### BACKGROUND

AI systems are increasingly deployed in real-world infrastructure environments, where they perform complex decision-making and coordination tasks previously reserved for human operators. AI systems can include agents or components assigned specialized functions such as monitoring, planning, control, and/or verification, where the agents interact in real time across architectures. Agents can be assigned varying roles and/or levels of authority. An agent can be or include a program or system that can perceive its environment, make decisions, and/or act autonomously or semi-autonomously to achieve specific goals.

Multiple agents in a set of agents can interact to carry out a set of operations. Conventional agent orchestration techniques, such as rule-based schedulers, workflow engines, and container orchestration platforms, were not designed to manage interactions among autonomous agents with varying roles and levels of authority. Legacy systems generally assume static trust relationships, centralized control, and predictable execution flows, which can limit utility of these systems in orchestrating AI agents that operate under changing conditions, delegated control structures, and/or policy-based constraints. These terms refer to specific challenges in managing AI agents: “changing conditions” means the environment or situation is dynamic and unpredictable; “delegated control structures” imply that decision-making authority is distributed among agents or systems rather than being held centrally; and “policy-based constraints” are rules or guidelines that govern the behavior and decision-making of AI agents within the system. For example, conventionally, identity and access control for non-human actors such as AI agents is typically handled through service accounts, tokens, and/or hardcoded credentials. These mechanisms provide minimal support for structured authorization, role-based boundaries, or policy-constrained behavior. As a result, AI agents are frequently over-permissioned or under-constrained, creating security risks and limiting the traceability of decisions.

The absence of a unified trust framework for AI agents and their orchestration environments hinders the ability to enforce compliance, reduce operational risk, and ensure accountability. In applications such as electrical grid management, industrial automation, and/or healthcare, it is desirable for trust boundaries to be both precise and enforceable, particularly when decisions are made or acted upon by autonomous or semi-autonomous components. Such components may interact with existing systems through interfaces originally designed for human operators, including graphical user interfaces (GUIs). Without structured identity and control models for non-human entities, organizations can face barriers to agentic AI adoption, scalability, and audit readiness.

Moreover, as organizations increasingly rely on third-party AI models, external data sources, and/or federated control architectures, there is a growing need for systems that can assign, verify, and/or enforce granular trust relationships among distributed, autonomous or semi-autonomous components. Use cases for such systems give rise to requirements that the systems support cryptographic identity, verifiable action provenance, and enforcement of business and/or regulatory policies in real time.

### BRIEF DESCRIPTION OF THE DRAWINGS

FIG. 1 is a diagram illustrating identity-based authentication and certificate issuance for different trust categories within a multi-agent AI system, according to some arrangements.

FIG. 2 is a diagram showing the relationship between assigned roles, signed publications, and synchronized collections in a trust-enforced orchestration framework, according to some arrangements.

FIG. 3 is a diagram depicting system bootstrapping and certificate publication distribution, followed by publication creation, trust validation, and secure distribution, according to some arrangements.

FIG. 4 is a flow diagram illustrating a large language model (LLM) query with context data and logging, including data validation, agent processing, and forensic log capture, according to some arrangements.

FIG. 5 is a detailed block diagram expanding on FIG. 4, showing agent interactions, publication signing, collection synchronization, and certificate validation, according to some arrangements.

FIG. 6 is a conceptual diagram illustrating Federated trust between two domains using trust relays and cross-signed certificates, including certificate chains and collection flow, according to some arrangements.

FIG. 7 is a certificate hierarchy diagram showing cross-domain trust validation through certificate chains anchored in distinct trust roots, according to some arrangements.

FIG. 8 is a system diagram showing a Multi-Agent Decentralized Trust Framework (MADTF) deployment across edge, cloud, and third-party entities with trust rules, identity attestation, credential rotation, and secure publication across secure and insecure execution environments, according to some arrangements.

FIG. 9 is a network diagram illustrating a representative computing environment in which a secure orchestration system, such as a MADTF, operates across distributed cloud and edge components.

In the present disclosure, the drawings have not necessarily been drawn to scale. Similarly, some components and/or operations can be separated into different blocks or combined into a single block for the purpose of discussion of some of the implementations of the present technology. Moreover, while the technology is amenable to various modifications and alternative forms, specific implementations have been shown by way of example in the drawings and are described in greater detail below. The intention, however, is not to limit the technology to the particular implementations described. On the contrary, the technology is intended to cover all suitable modifications, equivalents, and alternatives.

### DETAILED DESCRIPTION

AI agents are capable of performing computer-based operations autonomously or semi-autonomously. For example, AI agents can perform CRUD (create, read, update, delete) operations in databases to add, delete, or modify stored data. An AI agent with overly broad permissions can access sensitive data or perform unintended actions, such as modifying high-value assets or invoking critical services, due to the absence of structured authorization frameworks that could enforce granular, attribute-based access control. The lack of role-based boundaries prevents the agent from being restricted to its designated tasks and scope, while the absence of policy-constrained behavior means that the agent's actions are not evaluated against organizational security policies or compliance requirements, thereby exposing the system to potential security risks and compliance violations. For instance, a data analysis agent might be able to delete data or execute system commands due to its over-permissive access profile, highlighting the need for more precise controls.

The rapid evolution and widespread deployment of AI systems has created an urgent need for frameworks that not only enable communication and operational control of multi-agent systems, but enforce trust, secure identity, and maintain operational governance. Accordingly, the inventors recognized a need for an orchestrator framework that can manage non-human identities as first-class actors (entities that are treated with the same level of identity, authentication, and authorization as human users, with their own distinct roles, permissions, and access controls), enforce structured trust relationships among agents, support secure policy enforcement, interface with systems via mechanisms originally designed for human operators (e.g., GUIs or dashboards), and provide a scalable foundation for coordinating AI systems in enterprise and infrastructure environments. The solution described herein addresses the aforementioned technical problems through the integration of decentralized identity controls, cryptographic validation, publish-subscribe communication, and agent-level enforcement mechanisms within an orchestrated, multi- agent environment.

As used herein, the term “agent” and similar terms (e.g., “co-pilot”, “logic”) refer to entities that interact with their environment, process information, and/or take actions to achieve specific goals or objectives. An agent can be thought of as a software, firmware and/or hardware component that encompasses characteristics (e.g., traits, attributes, properties, and/or knowledge), states (e.g., user question or its derivatives, agent feedback), and/or agent interaction rules that govern its behavior and communication with other agents. The agent definitions can include references (e.g., programmatic bindings, function calls, local copies of) to AI models that define agents' decision-making processes and behaviors. Instantiating (spawning) an agent refers to the process of creating a new instance of an agent entity, class or object, which can involve allocating memory for the agent's data structures and variables, initializing agent attributes, setting up agent communication channels, and activating agent reasoning and decision-making mechanisms. This process can be compared to creating a new thread or process in a computer program, where the instantiated agent operates as a separate entity, executing autonomously and interacting with its environment and other agents. Depending on the implementation, agents can take various forms, such as executables running on physical and/or virtual machines and/or robotic agents interacting with physical environments. In some cases, agents can be instantiated as containerized applications, leveraging technologies like Docker, or as serverless functions, utilizing platforms like AWS Lambda and/or Microsoft Azure. Additionally, agents can be implemented using various programming paradigms, including object-oriented, functional, or logic-based programming, and can be designed to operate in diverse domains, such as e-commerce, healthcare, finance, or transportation.

Agents can use physical or virtualized resources (e.g., processors, memory, cache, communication interfaces, devices, databases, servers, components of the AI stack) in any suitable combination. Particular ones of such resources can be statically allocated or dynamically allocated at runtime (e.g., to a particular agent or group of agents for a duration of a simulation session or a set of simulation sessions). Particular ones of such resources can be dedicated, shared among agents, or shared between an agent and other processes. Various components of agents (e.g., models, data stores, executables) or agents in a particular set of agents can be implemented across resources in a distributed manner. Accordingly, unless otherwise indicated by context or expressly noted, the terms “local” (as in “local agent”) and “node” (as in “agent node”) should not be automatically assumed to refer to a particular unitary physical resource.

As explained herein, the described solution comprises a Multi-Agent Decentralized Trust Framework (MADTF), combining AI, Information-Centric Networking (ICN), and identity controls for non-human identities (NHI). MADTF supports decentralized coordination between agents, workloads, and services using secure cryptographic identity, policy-bound publication control, and verifiable inter-agent communication. MADTF can operate over various ICN protocols, including but not limited to Named Data Networking (NDN), Content-Centric Networking (CCN), Mobility First, and extensible Internet Architecture (XIA). In some embodiments, it uses Message-Oriented Middleware (MOM), Message Queuing, or brokerless publish/subscribe networks such as Defined-Trust Transport (DeftT) (see, e.g., www.ietf.org/archive/id/draft-nichols-iotops-defined-trust-transport-07.html), which builds on NDN principles. Some embodiments incorporate Trusted Execution Environments (TEEs) to anchor identity enforcement and policy validation.

In various embodiments, MADTF can interface with orchestrators, policy engines, or data governance tools to support secure AI workflows across cloud, edge, and hybrid environments. As described herein, in various embodiments the MADTF can integrate with a range of orchestration and governance platforms, including Kubernetes, Argo Workflows, Kubeflow, Apache Airflow, and Amazon SageMaker, as well as Azure Synapse, AWS Lake Formation, and Google Cloud Vertex AI. These platforms manage pipelines, scheduling, metadata, and machine learning (ML) operations but lack native support for decentralized identity enforcement, Federated trust, or cryptographic publication validation-capabilities that MADTF is designed to provide.

### Agentic and Multi-Agent Systems

The MADTF framework supports both traditional multi-agent systems (MAS) and more advanced Agentic AI architectures. MAS typically coordinate multiple semi-autonomous agents-such as software processes, sensors, or domain-specific AI modules-to collaboratively complete distributed tasks. These systems are often found in orchestration frameworks, where agents contribute specialized capabilities to solve sub-problems, perform real-time monitoring, or enforce policy within edge, cloud, and hybrid environments. In contrast, Agentic AI systems go beyond static task execution by incorporating autonomous reasoning, dynamic goal setting, persistent memory, learning, and real-time integration with external tools or application programming interfaces (APIs). These agents can independently interpret complex inputs, optimize workflows, and adjust behavior based on feedback, often without requiring continuous human intervention. Advanced Agentic AI systems may sequentially reason through multi-step problems, perform toolchain integration, call APIs, and act across digital and physical domains. In some embodiments, Agentic AI may also include autonomous agents with user interface (UI) interaction capabilities, enabling them to browse websites, click buttons, or fill out forms using techniques akin to Robotic Process Automation (RPA) powered by LLM. These agents may employ visual perception, Document Object Model (DOM) parsing, and simulated input control (e.g., mouse and keyboard emulation) to operate software interfaces originally designed for humans. When combined in larger systems, such autonomous agents and MAS may expose heterogeneous interfaces, complicating coordination and integration. Accordingly, standardized protocols can help unify these interactions across components.

One example of such a standard is the Model Context Protocol (MCP), developed by Anthropic, which defines an open, extensible standard for secure interaction between AI systems and external tools or services. MCP enables AI agents to retrieve data, invoke functions, and maintain continuity across multi-turn tasks using a structured JSON- RPC-based interface. Google's Agent-to-Agent (A2A) protocol, Microsoft Azure AI Agent Service and Amazon Bedrock Agents complement this model by enabling direct, secure communication between AI agents operating across different platforms and vendors. These emerging standards, while offering the above-described capabilities, suffer from other shortcomings (e.g., identity-based policy enforcement and others), and align well with MADTF's support for identity-based policy enforcement, secure publication of interactions, and authenticated toolchain integration.

Both MAS and Agentic AI models are supported by MADTF's cryptographic identity system, trust-scoped communication, and policy-based authorization mechanisms. MADTF enforces structured interaction through signed publications, verifiable message flows, identity-based trust rules, and access controls that span organizations, infrastructure layers, and regulatory zones. Because Agentic systems are entrusted with greater autonomy and control scope, they present heightened cybersecurity risks-including unauthorized data access, adversarial manipulation, and identity spoofing. MADTF addresses these and other concerns through trust-bound identity assignment, authenticated communication, role-constrained access, and optional human-in-the-loop enforcement. A particular agent can be assigned a cryptographic identity (e.g., a unique cryptographic identity) with associated private key, certificate, and trust-scoped permissions. Actions taken by the system are cryptographically signed and logged to support provenance, forensics, and non-repudiation, and publications may be encrypted, timestamped, and retained in immutable, verifiable logs.

Agentic and MAS configurations span a broad range of application areas, including cybersecurity triage and Common Vulnerabilities and Exposures (CVE) prioritization; threat log analysis and autonomous response; defense intelligence gathering and Open-Source Intelligence (OSINT) synthesis; procurement research and document summarization; predictive diagnostics and patient claim automation in healthcare; engineering assistants, edge robotics, and GPS-denied navigation; virtual assistants for shopping, support, and finance; and high-frequency trading, fraud detection, scientific research acceleration, DevSecOps automation, and secure orchestration of LLM workflows.

### Trust Categories and Roles

In the MADTF framework, a particular agent can be assigned a cryptographic identity and a role associated with a trust category. Trust categories define the security context (e.g., internal, external, third-party), while roles specify permission levels and data and control access boundaries. These role assignments are enforced through named certificate issuance and validated according to Trust Rules on synchronized collections of signed publications. The agent publishes its outputs into collections governed by Trust Rules. These Trust Rules (or rules) determine which publications can be read or acted upon by other agents based on the identity and role of the publisher and subscriber. Agents with authorization and access to multiple trust domains may be permitted to relay or respond to publications across domains, subject to Federated trust mechanisms such as cross-signing, relay validation, or shared trust anchors. Roles can be granted to both human users and software entities, including long-running services, short-lived containers, or embedded agents. Trust Rules may define access policies by namespace, topic prefix, or certificate issuer, and the Trust Rules are themselves published, signed, and synchronized across the system. Example trust categories include internal, external, third-party, infrastructure, and human-facing domains. Common roles include administrator, data provider, certificate agent, control agent, observer, and trust rule editor. These assignments enable the system to define fine-grained permissions and enforce cross-domain policies through signed publications and trust-scoped identity validation.

### Identity Authentication

MADTF supports secure authentication for both human and non-human agents. Human users may authenticate through existing identity and access management (IAM) systems using passwords, biometric credentials, multi-factor authentication (MFA), or single sign-on. Non-human agents authenticate through cryptographic key pairs and role-based certificates issued by the MADTF Certificate Authority and governed by Trust Rules. These agents may include AI models, containers, workload runtimes, or sensors. These entities can be uniquely identified through certificate chains and identity-bound signing. Devices with hardware-backed key storage, such as Trusted Platform Modules (TPMs) or TEEs, may offer stronger assurance through remote attestation, which helps detect corruption of operating software and protects associated authentication and access controls. Complex agents such as LLMs may be hosted in cloud environments protected by secure enclaves and may use zero-knowledge proofs, container attestation, or trusted shims to validate their provenance.

Agents without native identity capabilities may be represented by proxies that interface with MADTF intermediaries to inject validated credentials or short-lived tokens into outbound requests. These proxies can be used to support access to legacy systems or external cloud services that do not implement MADTF directly. In these cases, the MADTF framework may apply Trust Rules to authorize such access while providing provenance tracking and logging for interactions. Credential issuance and rotation can be managed by MADTF mechanisms such as DeftT, enforcing policy-based constraints, expiration, and revocation across distributed trust domains.

Cloud-based agents can use cloud-native NHI mechanisms (e.g., Azure Managed Identity, AWS IAM Roles for Service Accounts) to anchor trust and establish identity. This approach provides a common identity layer for distributed AI systems across cloud, edge, and hybrid deployments.

### MADTF Transport and Resilience

In some embodiments, MADTF utilizes authenticated, policy-enforced data transport built on ICN principles. In some embodiments, MADTF uses publish/subscribe architectures based on protocols such as NDN or transport overlays like DeftT, which decouple content from location and enable named data to be cryptographically signed, verified, and selectively synchronized across agents. Communications may also employ MOM, either brokered or brokerless, configured to support one or more messaging models, including publish/subscribe and message queuing. In the publish/subscribe model named topics corresponding to trust-controlled namespaces and signed publications are routed to authorized subscribers based on Trust Rules. In the message queuing model, MOM may provide durable, ordered delivery of signed publications, particularly in scenarios involving intermittent connectivity or asynchronous processing across distributed agents. In some embodiments, ICN-based message queuing may be implemented using naming conventions, sequential publication synchronization, and/or overlays such as Defined-Trust Transport (DeftT) to provide durable and ordered delivery among asynchronous or intermittently connected agents. More generally, message queuing can be implemented using various models, such as point-to-point message queuing (where a message is sent from one sender to one specific receiver), message streaming (continuous streams of messages for real-time data processing), message queuing with fan-out (delivering a single message to multiple recipients or queues), store-and-forward message queuing (storing messages until they can be forwarded to their destination), or a combination thereof.

Publish/subscribe transports in MADTF can support multi-path routing and opportunistic forwarding, enabling secure delivery even in intermittent, degraded or partitioned networks. These mechanisms enable granular data exchange, policy-constrained dissemination, and cryptographically attributable interactions for both human and non-human agents. Because messages are content-addressed and verified by role-bound certificates, agents can securely rejoin and reconcile synchronized collections after periods of disconnection, supporting resilient, asynchronous operation across edge, cloud, and hybrid environments.

For brevity and readability, the terms “publish” and “subscribe”, as well as related terms, such as “publication” and “subscription”, are used throughout this disclosure when referring to the process of exchanging electronic messages among entities. These terms are intended to encompass various implementations of such operations in one-to-one, one-to-many, or many-to-many architectures, including, for example, publish/subscribe (or other similar paradigms such as event notification, topic-based messaging, and the like), message queuing, message broadcast, event-driven messaging, and the like.

### Trusted Computing Environment

MADTF supports deployment in TEEs, which offer hardware-based isolation of sensitive logic and cryptographic credentials from the general-purpose Rich Execution Environment (REE). TEEs enable secure key storage, runtime attestation, and policy enforcement, even in the presence of compromised or untrusted REE software, making them particularly well-suited for applications in real-time, embedded, or industrial control environments. Validator components may run inside a TEE to verify publication signatures, enforce Trust Rules, and authorize data exchange. TPMs, Intel SGX enclaves, or ARM TrustZone may be used to anchor NHI credentials and perform secure signing. In some embodiments, the REE hosts containerized workloads (e.g., executables invoked by agents) and the TEE monitors agent state through attestation. If a violation or integrity failure is detected, the TEE may trigger a secure restart of affected containers, either locally or in response to signals from external MADTF agents such as a Trust Console. This coordination enables MADTF to maintain operational trust, restoring workloads to a known good state while preserving cryptographic auditability across the system.

### Toolchain Integration

MADTF can integrate with both DevSecOps pipelines and orchestrator frameworks to provide end-to-end trust enforcement across the AI system lifecycle. In DevSecOps environments, MADTF supports secure interaction with build systems, scanners, deployment agents, and runtime instrumentation. Dynamic credentials may be injected into continuous integration/continuous deployment (CI/CD) components, enabling identity-based control over artifact generation, software bills of materials (SBOM) creation, and secure publication. Integrations may include OpenTelemetry for observability, Sigstore for signature verification, and CycloneDX for generating SBOMs, enabling for reproducible, auditable workflows. Additionally, the MADTF framework can be configured to interoperate with at least one managed AI agent service, including but not limited to Azure AI Agent Service or Amazon Bedrock Agents, and/or with at least one AI orchestration framework, such as Microsoft Autogen, Semantic Kernel, LangChain, or Hugging Face Transformers, to facilitate trust enforcement at the software level. In such cases, MADTF may use compatible languages (e.g., Python, C++) and integrate via APIs or message handlers within the orchestration layer. Frameworks such as asyncio can be leveraged for secure, asynchronous publish/subscribe messaging between agents. This alignment enables MADTF to interact with broader cloud ecosystems-such as Azure Data Lake, Microsoft Purview, or Azure Cognitive Services-while maintaining decentralized policy control and cryptographic traceability. Agents and services such as these operate at various levels of the overall solution software stack, but all are supported alone or in groups by the MADTF.

The preceding descriptions are not intended to be prescriptive or limiting but rather to elucidate the value of implementing the MADTF, within the above-described as well as similar software toolchains, as the underlying orchestrator framework.

### SYSTEM DESCRIPTION

A detailed description of the MADTF is described in reference to the figures.

### Authentication and Integrity

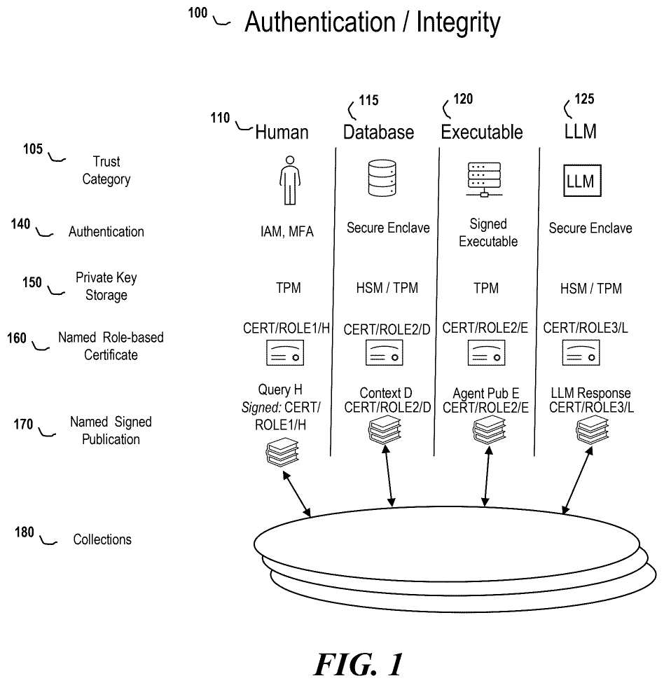

FIG. 1 is a diagram illustrating identity-based authentication and certificate issuance for different trust categories within a multi-agent AI system, according to some arrangements. In particular, FIG. 1 illustrates aspects of a provisioning process for Authentication and Integrity 100 for different Trust Categories 105, such as Human 110, Database 115, computational Executable 120, and LLM 125. The methods of Authentication 140 for can vary based on a particular trust category or other factors. A Human 110 can establish their identity with an IAM system such as Active Directory that can include passwords or other MFA approaches such as a hardware security token, a smart card, a biometric authentication token, a one-time password (OTP), a Universal 2^{nd} Factor (U2F) token, and so forth. A software component Executable 120 (e.g., a deployed executable) can be authenticated using a signed executable binary, a code signing certificate, a container signature, and so forth. A large LLM 125 server or a database 115 can be hosted in a secure encrypted private cloud enclave with authentication controls on access to the enclave, such as Role-Based Access Control (RBAC), Attribute-Based Access Control (ABAC), Multi-Factor Authentication (MFA), Identity Federation, JSON Web Tokens (JWT), Network Access Controls (NAC), IP whitelisting, Virtual Private Network (VPN) connections, and so forth.

The Trust Categories 105 can have respective methods for Private Key Storage 150 for asymmetric private keys of cryptographic public/private key pairs of the respective category. The corresponding public key in the particular key pair can be provided to an Admin certificate agent that creates a Named Role-based Certificate 160 though a Certificate Signing Request (CSR) process. A CSR can be an electronic message sent from an applicant to a Certificate Authority (CA) to request a digital certificate. The message can include the applicant's public key and/or identifying information, such as organization name and/or domain name. For example, a particular Human agent 110 can receive a Named Role-based Certificate 160 that includes the public key of the key pair together with an ICN name of CERT/ROLE1/H, indicating that Human agent H is assigned ROLE1, which grants certain access permissions according to the Trust Rules (not shown). This certificate can be signed by the privileged private key of the Admin certificate agent whose signing certificate ICN name is also included in the CERT/ROLE1/H certificate for later validation of the certificate (not shown). The Admin signs the certificate if they agree these ROLE1 permissions are appropriate. Any subsequent changes to the certificate, such as modifying the Role name with its corresponding access permissions, can invalidate the certificate signature. Accordingly, it can be very difficult for malicious actors to change the Named Role-based Certificate 160 without having the carefully guarded private key of the certificate agent to re-sign it.

As illustrated in FIG. 1, most of the agents have distinct Role names, although sharing the same Role name and permissions is also possible. This is shown for the Database 115, which has a Named Role-based Certificate 160 with ROLE2 with suffix D, while the Executable 120 Named Role-based Certificate 160 shares ROLE2 but with suffix E. In this example, if Human 110 publishes Named Signed Publication 170, Query H, “Who is the president of France?,” the publication can be signed by the Human Private Key 150 and can include metadata indicative of the name of the Named Role-based Certificate 160, CERT/ROLE1/H, and the appropriate named certificate is used to later validate the Signed publication. This publication validation can be approved after verifying all the signatures are valid and that the Trust Rules enable Human H with Role ROLE1 to publish a Query Publication (not shown). The LLM 125 can subscribe to the Query Collection to process Query H upon verifying that LLM 125 is allowed by the Trust Rules (not shown) to subscribe to the Query Collection in Collections 180.

### Roles and Publications

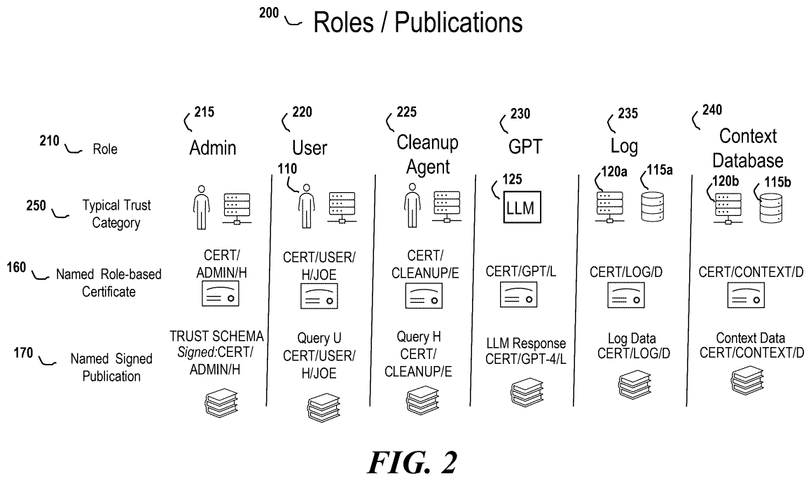

FIG. 2 is a diagram showing the relationship between assigned roles, signed publications, and synchronized collections in a trust-enforced orchestration framework, according to some arrangements. For example, FIG. 2 shows an example relationship between Roles and Publications 200. As shown, distinct Roles 210 include Admin 215, User 220, Cleanup Agent 225, GPT 230, Log 235, and Context Database 240. Individual entity agents assigned to each Role 210 belong to Typical Trust Category 250, such as Human 110 and/or LLM 125. For example, as shown, the Log 235 and Context Database 240 Role 210 each have a Trust Category 250 with both a Database (115a, 115b) and an Executable (120a, 120b) agent. A particular Role 210 name can be included in the corresponding

Named Role-based Certificate 160. A particular Named Signed Publication 170 can be signed by the private key associated with the Named Role-based Certificate 160. For example, a particular Human 110 agent, named Joe, when assigned the role of User 220, can be granted a Named Role-based Certificate 160 with the ICN name CERT/USER/H/JOE and can then publish Named Signed Publication 170 into the collection Query U. This Named Signed Publication 170 includes the certificate name CERT/USER/H/JOE that can later be used to select the correct Named Role-based Certificate 160 to validate the publication and Trust Rules (not shown).

The LLM 125 can subscribe to the collection Query U upon verifying that the Trust Rule for the Role 210 of GPT 230 with the Named Role-based Certificate 160 name of CERT/GPT/L enables it. To establish trust, the LLM 125 can retrieve the CERT/USER/H/JOE certificate from its synchronized certificate collection and verify the Query U publication signature using the associated certificate. This verification process involves confirming the certificate's validity via the trust chain. The trust chain may include a hierarchical sequence of certificates, signed by the next higher-level certificate authority, that establishes a chain of trust from a trusted root certificate authority to the certificate being verified. By validating the trust chain, the LLM 125 ensures the certificate is genuine and not revoked or tampered with. After verifying the certificate, the LLM 125 consults the Trust Rules to ensure the publication is authorized and unmodified.

### System Bootstrapping and Publication Distribution

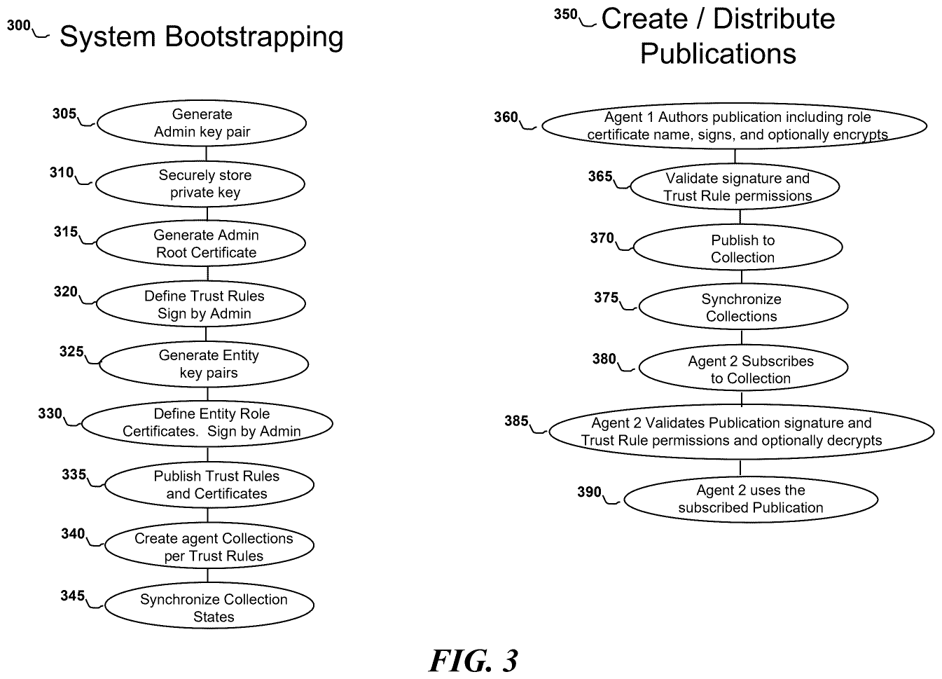

FIG. 3 is a diagram depicting system bootstrapping and certificate publication distribution, followed by publication creation, trust validation, and secure distribution, according to some arrangements. For example, FIG. 3 describes aspects of operations for implementing System Bootstrapping 300 and Create/Distribute Publications 350.

In the example System Bootstrapping process 300 illustrated in FIG. 3, a trusted Admin agent generates a cryptographic asymmetric public/private Admin key pair 305. In this example, the Admin agent, alternatively referred to as a Certificate Authority (CA), can issue certificates and also generate Trust Rules. The Admin key pair 305 is the root of trust of the MADTF and the private key is securely stored 310, typically protected with a Hardware Security Module (HSM) in a locked non-Internet-connected facility. The Admin generates an Admin Root Certificate 315, also called a trust anchor certificate. This root certificate can be self-signed or signed by a higher trust level authority in the Admin HSM. The Admin has a Trust Console or agent that enables them to generate Trust Rules defining what actions Role 210 is allowed to perform. The Admin generates the Trust Rules publication, which includes a version identifier or hash of the rule set, and signs it 320 with the root Admin private key 310. A particular Trust Rule set may be referenced by name or content hash within issued certificates or collection metadata to ensure policy traceability and validation at runtime. Key pairs are generated for a particular entity agent in the MADTF system 325 and are used to establish and authenticate their identity and Role in the MADTF. Key pairs are often generated after the Trust Rules are defined and when a new entity joins the system; however, Trust Rules can be updated and defined after key pairs are generated. For example, this can be done: (1) through a CSR process to the Admin, where the key pairs are generated locally by a particular entity and the private key is retained while the public key is provided to the Admin for certificate signing, and/or (2) when the key pairs are generated by the Admin directly, who then delivers certificates and the private key to a particular entity agent. The Admin then defines the Roles 210 in the MADTF system, and if the Admin authenticates and authorizes the requesting entity agent, the Admin creates the new agent ICN Named Role-based Certificate 160, including the agent Role name, the public key of the key pair, and the name of the Admin Root Certificate 315, and finally signs this new certificate 330 with the root private key 310. The Admin publishes the Trust Rules and the Certificates 335 to separate collections so that all entity agents in the MADTF have access to the certificates to validate all publications, including the certificates themselves. Within a particular distributed agent of the MADTF system, the Trust Rules specify which publication Collection to create 340 and the Collection States are Synchronized 345 by copying publications from Collections where they reside to other Collections that are lacking them so that all entity agents achieve a common set of publications in their Collections.

In the example Create/Distribute Publications process 350 illustrated in FIG. 3, in the MADTF, such as LLM Query and Response publications, Agent 1 authors the publication including the ICN name of their Named Role-based Certificate 160, signs it with their private key, and optionally encrypts the Publication 360. Encryption policies (if applied) are defined within the Trust Rules or publication metadata, specifying which agent roles are authorized to decrypt the content (e.g., to enable trust-based filtering by receiving agents). Prior to enabling the publishing step, the distributed entity agent MADTF validator checks the entity certificate signature validity with the root of trust and verifies that the Trust Rules enable the entity Role name to publish to the desired Collection 365. If the agent MADTF validator validates the publication, it is published to the selected Collection 370 and the Collection Synchronizes 375 with those of all MADTF entity agents. Agent 2 subscribes to the Collection 380 and Entity 2 validates the publication signature and the Trust Rule for subscription and optionally decrypts the publication 385 so that Agent 2 can now use the subscribed Publication 390.

### LLM Query With Context Data and Logging

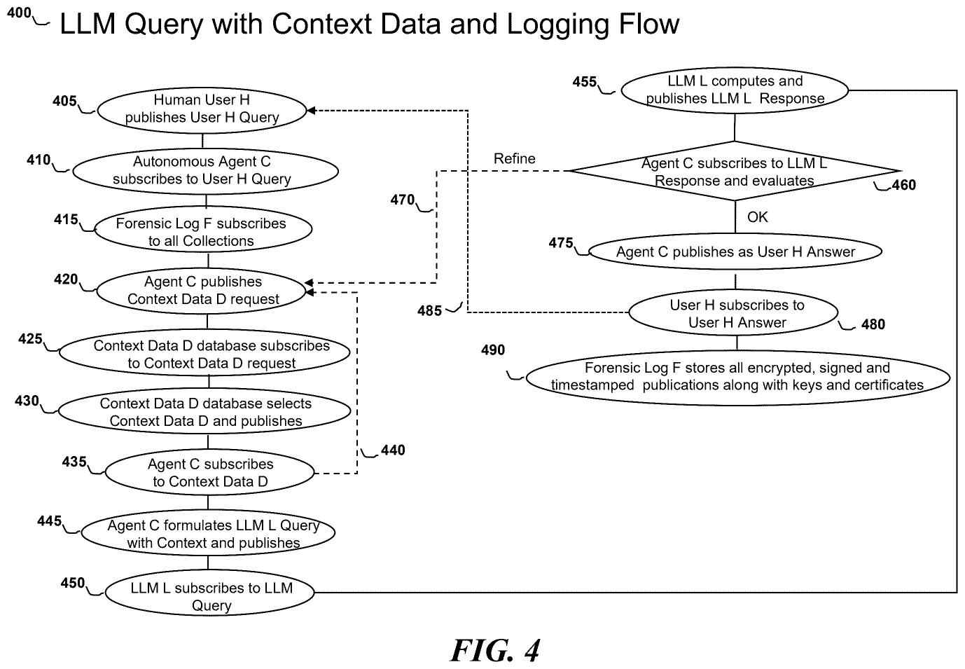

FIG. 4 shows LLM Query with Context Data and Logging Flow 400, such as those for data validation, agent processing, and forensic log capture, according to some arrangements. A Human H agent with the Role 210 of User 220 publishes to a User H Query Collection 405. An autonomous Executable Agent C subscribes to the User H Query Collection 410 while the Forensic Log F agent subscribes to all Collections 415. Agent C serves as an orchestrator and is responsible for gathering, validating, and refining query inputs and LLM outputs. Using the User H Query it has received, Agent C publishes to the Context Data D request Collection 420, which the Context Data D database agent subscribes to 425. The Context Data D database agent selects the best context data for the received Context Data D request from its vector database and publishes to the Context Data D Collection 430. Autonomous Agent C subscribes to the Context Data D Collection 435, and if Agent C is not satisfied with the received Context Data D, it may optionally refine the Context Data D request and republish it to the Context Data D request collection 440. Agent C then combines the User H Query with the approved Context Data D to form an expanded query that it publishes to the LLM L Query Collection 445, which the LLM L agent subscribes to 450. Based on the received expanded LLM Query with Context Data D, LLM L computes and publishes a response to the LLM L Response Collection 455, which Agent C subscribes to and evaluates 460 to determine if the LLM L Response should be further refined. Autonomous Agent C has some limited response analysis capability and if it determines the received LLM L Response is inadequate or lacks proper Context Data D, it can optionally publish a revised Context Data D request 470 and can optionally retry the process by issuing a revised Context Data D request, reformulating the expanded query, or both to help refine the response. If Agent C approves the LLM L Response, it publishes it as the Answer to the User H Answer Collection 475, which Human User H subscribes to 480. If Human User H is not satisfied with the User H Answer, they can optionally refine the User H Query and republish it to the User H Query Collection 485. Based on HIL judgment or assisted user interface (UI) interpretation, Human H may refine the original query and republish to ensure that subtle errors or misdirections of the agentic response are corrected. Meanwhile, Forensic Log F may have subscribed to all of the collections 490 and thus may have all signed and optionally encrypted publications along with the certificates, Trust Rules, and keys to validate and decrypt these. It can store these in a large Forensic Log long-life database in encrypted form, with sequential nonces and immutable timestamps that ensure append-only, tamper-evident integrity. Thus, the multicast capabilities of the MADTF may ensure that the Forensic Log F receives all of the publications in a verifiably unaltered form for forensic and provenance analysis.

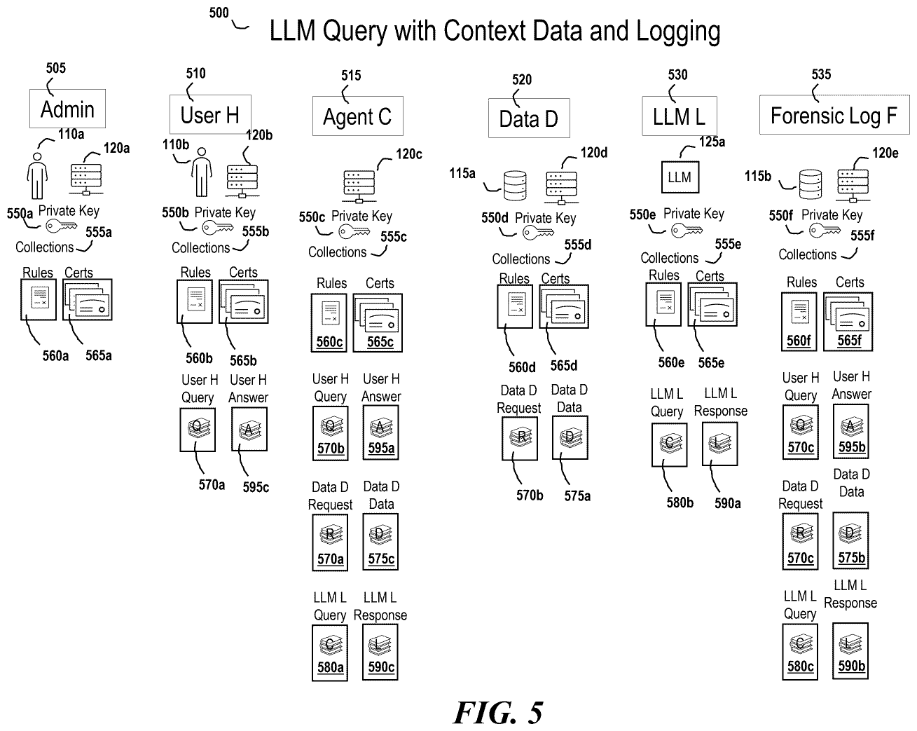

FIG. 5 shows a more detailed view of the LLM Query with Context Data Logging 500 that expands upon the discussion in the earlier figures and illustrates further aspects of agent interactions, publication signing, collection synchronization, and certificate validation, according to some arrangements.

In the example illustrated in FIG. 5, the MADTF system includes five agent entity Roles 210: Admin 505, User H 510, Agent C 515, Context Database Data D 520, Large Language Model LLM L 530, and database Forensic Log F 535. Each agent is controlled by at least one of a human user (two such human users 110a and 110b are illustrated) and/or a computer Executable 120a-e, or an LLM 125a. The agent may optionally have database storage 115a, 115b. Each agent has a fundamental cryptographic identity defined by an asymmetric key pair wherein the private key 550a-f is securely stored in an HSM or TPM, while the corresponding public key is contained in a role-based certificate signed by the local Admin CA private key 550a, which are all published by the Admin to the synchronized Certs Collection 565a-f. In this example, the Admin 505 agent consists of a human administrator 110a with an ultra-secure computer Executable 120a. As part of the MOM in the MADTF framework, in this example, publish/subscribe makes use of set reconciliation to synchronize collections of publications between agents. Admin 505 publishes a unified Trust Rule set and Certs Collection, synchronized to each agent (560a-f, 565a-f).

The Trust Rules are signed for authenticity and immutability by the Admin private key 550a and published to the synchronized Trust Rules 560a-f, which can be a rules collection. The Trust Rules define which Roles have the authority to publish or subscribe to specific synchronized Collections of Publications 555a-f. At every transport step, where a publication is either published from or subscribed to, a comprehensive validation is performed: signatures of Cert Collection 565a-f and Trust Rules 560a-f can be verified against the root of trust Admin certificate that is also included in Certs Collections 565a-f, and the allowed agent Collections 555a-f topics are checked against the Trust Rules 560a-f. Any publication content-specific restrictions in the Trust Rules are also validated through appropriate publication content parsing. In the following description, the validation specifics at each step will generally be omitted for clarity.

Human user 110b of agent User H 510 gains access to computer Executable 120b through a MFA process. Computer Executable 120b contains a securely stored private key 550b that establishes the fundamental identity for agent User H 510. User H is authorized by the Trust Rules and their Named Role-based Certificate to perform certain Context Queries. Human 110b poses the query, “What is the material cost of a watch, part number T-43?” User H is a low-level accounting role and is restricted through a zero-trust query template to only pose queries of the explicit form, “What is the material cost of . . . ,”per Trust Rules 560a-f. Thus, broader business-sensitive queries like “What is the business profit margin?” will be rejected, as will be seen. Computer Executable 120b uses private key 550b to immutably sign a User H Query Publication that is synchronized in the User H Query Collection 570a-c. The published User H Query is for the material cost, with a header naming the corresponding User H Named Role-based Certificate in the Certs Collection 565a-f. This role-based naming can be specific to a single User H, as in this example, or can be more general and hierarchical, such as “Low Level Accounting/User H,” if there are multiple employees with similar privileges (not shown). User H Query 570a-c is then automatically synchronized to only two other entities, Agent C 515 and Forensic Log F 535, as defined in Trust Rules 560a-f. In addition to signing, all publications can optionally be encrypted for confidentiality with the symmetric encryption/decryption keys securely distributed, but this step is omitted here for clarity.

Forensic Log F 535 keeps a log, in tamper-evident format, of the superset of all publications in all Collections topics 555f, where 555f refers to the Forensic Log's superset collection, synchronized with all other agents' publication topics found in Collections 555a-e. The superset is defined by the Forensic Log F 535 topic subscription rules defined in Trust Rules 560f. If the publications are not already timestamped, computer Executable 120e in Forensic Log F 535 sequentially timestamps and encapsulates signed publications in a secondary signed wrapper, preserving original content integrity for validation, and stores it in the database storage 115b. A sequential nonce can also be added to the database entries prior to re-signing to ensure that additional intermediate database entries are not later added. For forensics, each publication can be validated to ensure that it is has not been tampered with by validating both the Forensic Log F 535 signature and the original publisher of the publication (one of the other agents) using the corresponding stored public key certificates in the Certs Collection 565f in the Database 115b. The original publication signature establishes cryptographically secured provenance on who originally signed each publication. In addition, authorizations per the Trust Rules 560f, which are also stored in the forensic database, can be checked.

Autonomous Agent C 515 subscribes to Collection topic User H Query 570b and validates the publication signature using the corresponding User H certificate in the Certs Collection 565c. It also parses the Query text checking against the Query template (not shown) with permissions as defined in Trust Rules 560c. Computer Executable 120c determines that the User H Query is of the correct form, “What is the material cost . . . ” Agent C computer Executable 120c then adds a Context Data D request publication to the synchronized Data D Request Collection 570a-c, which is subscribed to by the Data D 520 computer Executable 120d. It then performs a context data search for records in its Database 115a relevant to the query, “What is the material cost of a watch, part number T-43?” and retrieves two files: Part number “T-43 Bill of Materials” and “T-43 Parts Price List.” Computer Executable 120d combines and publishes these to the synchronized Context Data D Data Collection 575a-c, subscribed to by Agent C 515.

Next, Agent C 515 concatenates the User H Query with the Context Data D Data publication to form a composite publication added to the synchronized LLM L Query Collection 580a-c and of the form, “Given these two files: ‘Part number T-43 Bill of Materials’ and ‘T-43 Parts Price List’; ‘What is the material cost of a watch, part number T-43?’” LLM 125a in agent LLM L 530 subscribes to the LLM L Query Collection and formulates a response published to the synchronized LLM L Response Collection 590a-c. This response could be of the form: “The T-43 watch has a material cost of $9.71.” Agent C 515 computer Executable 120c can further attempt to check that LLM L Response publication is in fact a watch cost and not some other privileged information like Profit Margin (as required by Trust Rules 560c); however, due to the complexity of interpreting natural language responses, this will be difficult to parse with relatively simplistic computer Executable 120c, and while full content verification may not be feasible, Agent C 515 uses prompt templating and publication tagging to restrict downstream use and enable post-hoc audit validation. Agent C 515 then prepares a publication added to the synchronized User H Answer Collection 595a-c. Computer Executable 120b in agent User H 510 subscribes to the Collection and relays the User H Answer that is in response to the original User H Query in Collection 570a to Human 110b. Throughout this process, all of the inter-agent transactions publications are fully secure and precisely controlled though the Trust Rules 560a-f and are immutably logged in Database 115b as part of the agent Forensic Log F 535 through multicast collection synchronization.

### Logging

Secure logs can be advantageous to use in distributed AI systems, such as those operating under a Federated trust framework. These systems, which often span across various organizations and geographies, inherently face complex security and privacy challenges. Secure logs are essential for maintaining a detailed record of all activities and transactions that occur within the system, including data access, model updates, and user authentication. This logging is advantageous for several reasons. First, it helps in monitoring system performance and detecting anomalies or malicious activities that could indicate a security breach or system malfunction. By providing a transparent and immutable record of all actions, secure logs help in quickly identifying the source and nature of any issue, facilitating swift response and mitigation, or auditing by authorities.

Moreover, in the context of Federated trust, where data and resources are shared among various stakeholders without centralizing control, secure logs are useful for ensuring accountability and compliance with data governance policies. Within a Federated trust environment, the establishment of the provenance of which trust domain originated a publication and which trust domain it has transited is detailed, and the MADTF with Federated trust Relay Agent shims makes this possible. In the MADTF, Trust Rules can enforce permissions on which agents have access to selected Log publications. For example, Trust Rule permissions could restrict log access to only those records published by selected agents representing a subset of the full Forensic Log. This supports auditability, enabling organizations to verify that their data is being used appropriately and that all interactions with the system adhere to agreed-upon protocols and privacy standards. This is particularly important in sectors like healthcare and finance, where data sensitivity is high and regulatory compliance is stringent. Secure logs provide verifiable evidence that federated systems uphold data privacy, confidentiality, and security requirements, helping to build trust among participants. In regulated or infrastructure-related environments, such logging may be legally mandated to ensure transparency and auditability. By preserving integrity, confidentiality, traceability, and policy compliance, secure logs enhance the reliability, viability, and long-term sustainability of distributed AI systems operating across sensitive or cross-domain contexts.

The MADTF can be adapted to secure immutable logs in part due to its multicast publisher/subscriber (pub/sub) framework, which can enable the Log to subscribe to all the same publications that form the network traffic. This works together with the security fabric that signs each publication, cryptographically indicating its origin, or provenance, which is critical for AI systems. Additionally, publications can be optionally encrypted for confidentiality, and all of the MADTF security aspects apply to publications at rest as well as in transit or in use. Thus, the publications can be stored directly in their secured form along with the keys and certificates that are required to access and validate them since these keys and certificates are themselves publications that the Log will archive. Furthermore, the Log function can add timestamps and a sequential nonce metadata and optionally re-sign the data to form an immutable forensic log that can be fully attributed, that can be encrypted (with decryption keys under full access controls), and with the nonce and digital signing so that it cannot be later modified or have entries added or removed without detection.

### Federated Trust

In a large evolving AI ecosystem, numerous distributed and decentralized agents can interact. There are competing requirements for broad access to information to make the most informed responses or actions, together with the need to control proprietary data and privacy. Typically, different organizations can have access to unique proprietary data. The different organizations may be open to sharing their unique proprietary data in limited circumstances, often for a fee as part of a contractual agreement. The business arrangements can be complex.

In some cases, a company may have proprietary information, for example, journal articles from an academic journal publisher. A publisher might want to enable a particular external user, or multiple users in a company, to have access to selected articles but not the entire collection. This could be addressed by Retrieval Assisted Generation (RAG), in which the user submits a query and the journal publisher then can perform a vector database search and retrieve the best articles or articles that are most closely related to the query. The user might then include these context articles in a query directed to a separate vendor that hosts an LLM, resulting in best response to their query. RAG is useful in that it does not require expensive and time-consuming training of an LLM with proprietary data; this enables RAG to serve time-sensitive applications more effectively. Additionally, smaller companies may not have the resources to perform this training. Also, when performing time-consuming LLM training, the results can become out of date quickly, even for very well-funded models like ChatGPT. Another advantage of RAG is that the number of context prompt articles is small, typically ten or less, and the originating source of each article is known and this assists in establishing provenance. The MADTF system is very well adapted to reliably delivering publication-level context data that is individually signed for immutability and traceability to its source. However, one complication for the MADTF is that using a common trust anchor across company boundaries may not be supportable. Each company may want to cryptographically control their own information or may choose to use a different AI orchestrator framework than MADTF, so transitioning the company boundaries securely can be a challenge.

In some cases, companies may not want to share context data in full for a RAG process and may choose to instead use their proprietary data in a slim ML model that they control. For deploying ML on smaller systems with targeted datasets, a variety of efficient models exist, as alternatives to LLMs. This can be particularly useful to securely deploy AI agents on edge devices like mobile phones, which have more limited processing resources but can achieve greatly reduced latency and costs and superior autonomy by processing the AI model locally and not depending on uninterrupted mobile communications to a central cloud-based LLM. Decision Trees and Logistic Regression are straightforward options for classification tasks. Support Vector Machines and k-Nearest Neighbors provide flexibility for more complex patterns. Ensemble methods like Random Forest and Gradient Boosting Machines, including LightGBM (G. Ke et al., “LightGBM: A Highly Efficient Gradient Boosting Decision Tree,” in Proceedings of the 31st International Conference on Neural Information Processing Systems, 2017, pp. 3149-3157) and XGBoost (T. Chen and C. Guestrin, “XGBoost: A Scalable Tree Boosting System,” in Proceedings of the 22nd ACM SIGKDD International Conference on Knowledge Discovery and Data Mining, 2016, pp. 785-794), offer robustness and efficiency. For image and sequence data, smaller Convolutional Neural Networks and Gated Recurrent Units are effective. In other cases, fine-tuning of larger models with proprietary data can be useful but is still relatively labor intensive. However, models trained on proprietary data make it more difficult to establish provenance and proprietary data leakage may occur. Hence, controlling access to these models can be important. In all of these cases, a company can choose to invest in the infrastructure to host these smaller models using their proprietary data. They may be contractually open to sharing access to these proprietary AI models with other selected companies but may generally want to restrict access or to charge for it.

This scenario, in which separate companies or trust domains may each seek to maintain control over data or model access while interacting in a contractually limited manner, can be supported by the concept of Federated trust. The National Institute of Standards and Technology (NIST) Internal Report 8149 (D. Temoshok and C. Abruzzi, “Developing Trust Frameworks to Support Identity Federations,” NIST Interagency/Internal Report 8149 (January 2018); available at: doi.org/10.6028/NIST.IR.8149. [Accessed: Apr. 19, 2024].) addresses Federated trust and describes how trust frameworks can provide secure methods for leveraging shared identity credentials across various online service providers. It delves into the formation and implementation of identity federations, outlining the roles and responsibilities of participants including federation administrators, credential service providers, relying parties, and users. The report emphasizes the importance of trust frameworks in establishing mutual trust and governance within these federations. It highlights the need for privacy, security, and interoperability in managing personal identification information and facilitating secure online transactions as well as the system rules, legal structure, and conformance processes that are fundamental to the success of identity federations.

In some embodiments, the MADTF framework securely implements Federated trust through the use of a Trust Relay. The Trust Relay typically has separate interfaces in each of two or more trust domains, each their own root of trust, where a trust domain is defined as an MADTF with a unique root of trust. The Trust Relay can have a shim code that enables selected data (or publications) to transit from one trust domain and into a second trust domain. In the Trust Relay, independent Trust Rules in each trust domain control which data (or publications) are authorized to pass across the trust boundary. Thus, if, for example, an agent in trust domain A wants data D from trust domain B, this is only allowed if the trust domain A Trust Rules enable the agent to request the data D and if the trust domain B Trust Rules enable data D to be exported. These flexible Relay Trust Rules can be defined by the business contractual agreements required for Federated trust.

As part of these business relationships, trust domain B can sign trust domain A certificates as part of a CSR process to authorize their use in trust domain B. In some embodiments of the MADTF, the cross-signing of certificates in trust domain B from trust domain A may involve adding a single certificate (XB) in the trust chain that double-signs the trust domain A trust anchor certificate with the trust domain B trust anchor. This effectively cryptographically states that “all certificates and trust rules in trust domain A are trusted by trust domain B” and can be validated (e.g., using federated trust principles) by ensuring that at least a minimum set of domain entities have signed a particular certificate. A second double-signing relationship for the validation of publications originating from trust domain B into trust domain A typically uses a second cross-signed certificate consisting of the trust domain B trust anchor certificate double-signed by the trust domain A trust anchor (X_{A}). The full certificate signing chain can be rigorously validated for each publication and the full signing chain enables for the determination and validation of the full provenance of each publication in trust domain B, including those that were published from trust domain A and transited through the Trust Relay, and vice versa. This discussion on the Trust Relay covers information exchange between two trust domains across a single interface. An important extrapolation is to extend this to the complex web of multiple interconnected trust domains required to address the highly distributed future AI ecosystem. The Federated trust concepts in more complex configurations are the same with the addition of other cross-signing certificates added to the signing chain and with the associated Trust Relays.

In federated environments, where full MADTF-based certificate enrollment may not be practical for all external services or workloads, trust rule enforcement can be extended using scoped tokens. These tokens may include ephemeral access credentials, signed capability assertions, or session-specific keys and are issued under the control of MADTF trust rules. When external services lack native DeftT identities, a proxy or relay agent can act on behalf of the system to insert validated tokens or headers into outbound requests, enforcing trust boundaries without requiring structural changes to downstream services. Trust rules can govern the authorization to issue tokens, can define their scope and expiration, and can enable for delegation from a higher-level certificate authority when necessary. This mechanism enables non-native services to participate securely in MADTF-controlled workflows while enabling all actions to be attributable, time-limited, and verifiable within the trust schema. While tokens provide a degree of trust control across federated domains that do not typically employ MADTF-based certificates, for full interoperability Trust Domains typically share a minimal protocol and schema for publication metadata, certificate formats, and ICN naming, even if other orchestration details differ.

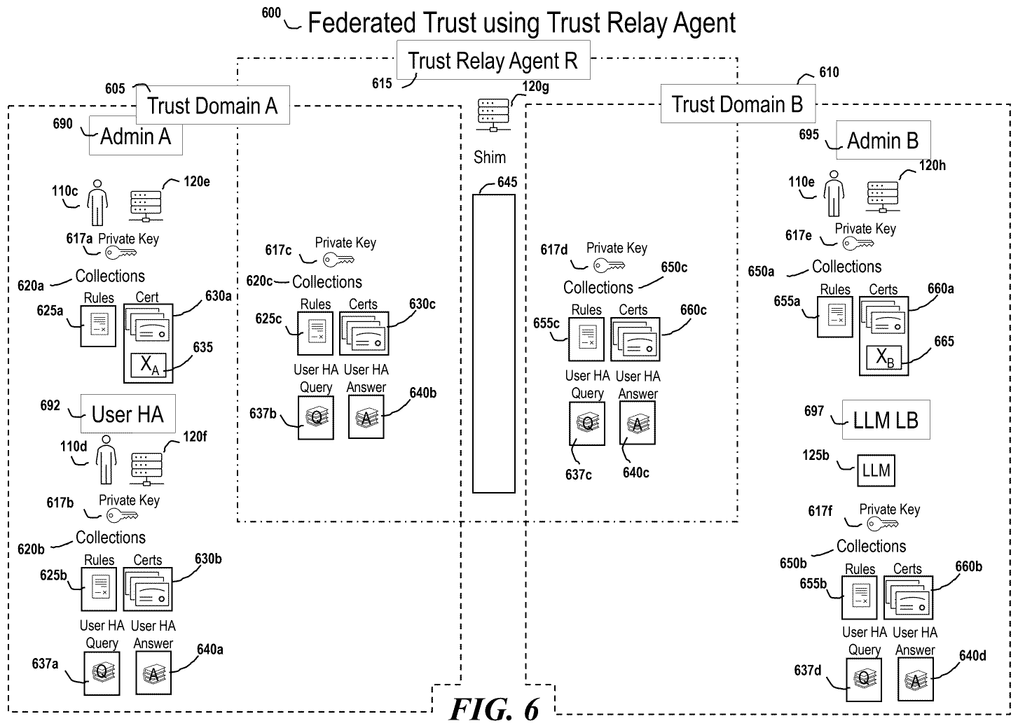

FIG. 6 provides an illustrative example of Federated trust 600 using MADTF for two Federated trust domains according to some arrangements, Trust Domain A 605 containing entities Admin A 690 and User HA 692, and Trust Domain B 610 containing entities Admin B 695 and LLM LB 697. In addition, there is a Trust Relay Agent R 615 entity that shares interfaces for both trust domains as well as a Shim 645 that controls which publications in the Collections 620a-c and 650a-c are allowed to pass between the trust domains as specified and controlled by Trust Rules 625a-c and 655a-c. As shown, these entities are composed of (or, more generally, can include) Humans 110c-e, computer Executables 120g-h and LLM 125b. Each entity has at least one unique private key 617a-f used to establish and control its identity. The Trust Relay R 615 is not an autonomous publisher. It enforces both sides' Trust Rules, and it may add metadata and signatures for audit logging. It does not generate or modify publications.

In a simplified certificate hierarchy, Admin A 690 uses their trust anchor private key 617a to sign Cert Collections 630a, in addition to Trust Rules 625a, for Trust Domain A 605 that are published to Collections 620a. As part of the MADTF, these collections are synchronized across all entities in Trust Domain A 605 as Collections 620a-c. For the purpose of validating publications originating from Trust Domain B 610, Admin A 690 also double-signs the self-signed trust anchor certificate of Admin B 695 producing cross-signed certificate XA 635, which is also included in the Cert Collection 630a. As determined by the Trust Rules 625c and 655c, some, but not necessarily all, publications pass through Shim 645 between the trust domains so that Trust Domain B 610 has a unique set of publications in its Collections 650a-c. In addition, there is an analogous cross-signed certificate XB 665 as part of the Trust Domain B 610 Cert Collection 660a-c.

As a simplified example of how a User HA 692 in Trust Domain A 605 can submit a User HA Query 637a-d to LLM LB 697 in Trust Domain B 610 and receive a response User HA Answer 640a-d, for purposes of illustration this example assumes that both queries and answers are allowed per the trust rules to fully traverse the Shim 645 so that these collections are synchronized across all entities in both trust domains. Thus, the User HA Query 637a is signed by Private Key 617b in User HA 692. LLM LB 697 can validate the Query Publication using the full certificate chain in Certs Collection 660b including XB 665. This includes certificates from Trust Domain A 605 that are allowed to pass Shim 645 from Cert Collection 630c to Cert Collection 660c.

LLM LB 697 can then generate and publish a response User HA Answer 640a-d that is signed by Private Key 617f and is synchronized across all entities. User HA 692 subscribes to User HA Answer 640a-d and can validate it using the full certificate chain in Certs Collection 630b including XA 635. The full certificate chain unambiguously and immutably establishes the provenance of who has generated each query and response and the full chain of trust that supports them.

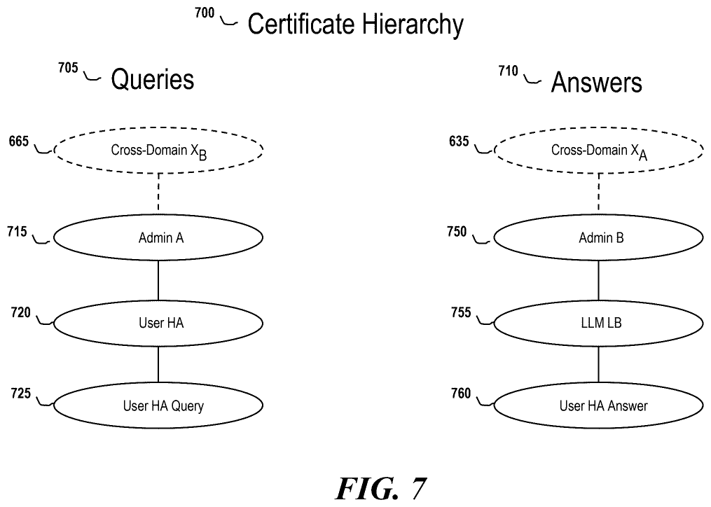

FIG. 7 shows the Certificate Hierarchy 700 used to sign and validate the Queries 705 and Answers 710 that were described in the FIG. 6 example, according to some arrangements. Admin A 690 is the certificate authority (CA) for Trust Domain A 605 and self-signs a root of Admin A trust certificate 715 for Trust Domain A 605. Self-signed certificates may not always be used, and the root of a trust certificate may in some cases be signed by a higher certificate authority. Admin A 690 also signs certificates for other entities in Trust Domain A 605 including User HA 692 to yield User HA certificate 720. For purposes of validating Answers 710 publications from Trust Domain B 610, Admin A 690 also double-signs the Trust Domain B 610 trust anchor certificate 750, which is passed through the Trust Relay Shim 645 prior to double-signing. This double-signed Cross-Domain Certificate XA 635, along with the Admin A 715 and User H 720 certificates, are all published to the Trust Domain A 605 Cert Collections 630a-c.

Similarly for Trust Domain B 610, Admin B 695 signs all certificates including those for Admin B 750, LLM LB 755, and the Cross-Domain XB certificate 665, which are published to the Trust Domain B 610 Cert Collections 660a-c. Next, all of the certificates in the Trust Domain A Cert Collections 630a-c and Trust Domain B Cert Collections 660a-c (with the exception of the Cross-Domain certificates 635 and 665) are shared through the Trust Relay Shim 645.

Finally, when User HA 692 in Trust Domain A 605 generates a User HA Query Publication 725, it signs the publication with its private key 617b and publishes it to the User H Query Collection 637a. When LLM LB 697 in Trust Domain B 610 subscribes to this User HA Query Collection 637d, it can validate the signature by using the chain of public key certificates: User H 720, Admin A 715, and Cross-Domain certificate XB 665, all of which are accessible in its Cert Collection 660b. For publications that originate and remain exclusively in Trust Domain B 610 (example not shown), the Cross-Domain certificate XB 665 would not be required since all of these Trust Domain B 610 publications would use the Admin B trust anchor certificate 750 as the ultimate trust authority. Similarly, the User HA Answer publication 760 can be validated by the User HA 692 using the LLM LB 755, Admin B 750, and Cross-Domain XA 635 certificates that are found in the Trust Domain A Cert Collection 630b.

In some embodiments, the MADTF framework may support dynamic runtime evaluation of trust using a calculated trust score or risk score. This score may be derived from multiple contextual inputs, including the sensitivity classification of the publication, the permissions associated with the requesting or publishing agent's role, and the authentication context-such as whether MFA was used, whether the agent is operating within a trusted network boundary, or other observed risk factors. The system may compare this trust score to a configurable risk threshold defined in the Trust Rules. If the score meets or exceeds the threshold, the publication or data access may proceed; otherwise, it may be denied or deferred. This mechanism enables fine-grained, policy-driven trust enforcement at runtime, which is particularly useful in Federated trust environments where agents operate across diverse trust domains and conditions may vary dynamically.

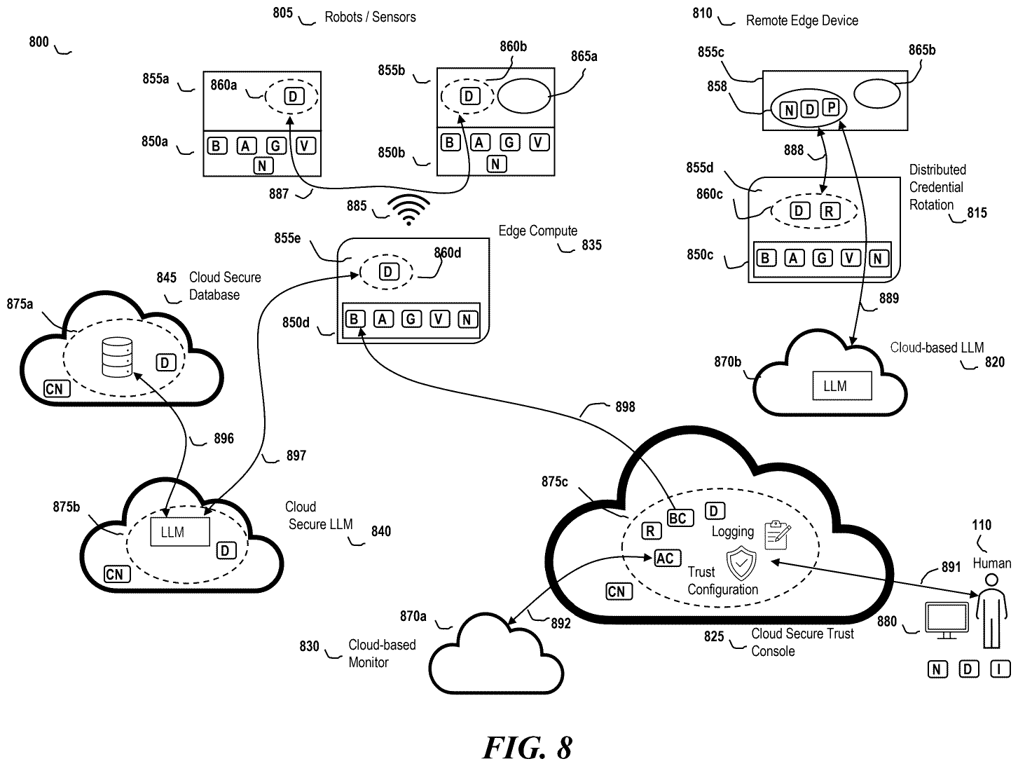

FIG. 8 shows a multiple entity MADTF 800 deployment across edge, cloud, and third-party entities with trust rules, identity attestation, credential rotation, and secure publication across secure and insecure execution environments, according to some arrangements. For example, FIG. 8 illustrates aspects of IAM across cloud and physical controllers. The hardware functions include Robots/Sensors 805, Remote Edge Device 810 gateways, a Distributed Credential Rotation server 815, an Edge Compute server 835, and an Administrator Controller 880. TEEs in hardware gateways and servers 850a-d contain critical control and security functions implemented within a secure operating system. These include non-human identity management (labeled N in the figure), typically with secure key storage in a TPM; a MADTF Validator (labeled V in the figure) that verifies all signed publications and ensures that communications conform to MADTF Trust Rules for access control; a Gating function (labeled G in the figure) that can block access to the REE if violations are detected; Attestation (labeled A in the figure) to monitor software integrity; and a secure boot mechanism (labeled B in the figure), which can restore container workloads or the entire TEE to a known good state in the event of compromise. The Real Execution Environments (REEs) 855a-e host both unsecured containers 865a-b and secure MADTF-enabled containers 860a-d, the latter implementing datacentric networking (labeled D in the figure). MADTF communication paths may include multicast radio 885 such as WiFi6 or LoRa, supported by IPV6 and MADTF transport-layer signing and policy enforcement. Typical TEE implementations in such systems may include ARM TrustZone or Intel SGX, and in gateway-class devices Real-Time Operating Systems (ROS) with Software Guard Extensions (SGX) is commonly used. Attestation data can include detailed information used to monitor software integrity, such as measurements of code, configuration, and execution state, including specifics like hash values of firmware or software, boot logs, system call sequences, and security settings, to verify the trustworthiness of a system or device.

The Cloud Secure Trust Console 825 serves as the central credential authority and policy coordination hub in the MADTF framework, managing certificates, Trust Rules, and system-wide access enforcement.

MADTF agents reside in robot/sensor gateways 855a-b, edge controllers 855d-e, and other trusted computing platforms. Each of these hosts one or more containers (860a-d, 865a) representing active workloads. These containers are attested to by their associated TEEs 850a-d using function (A) and operate under policies distributed from the Cloud Secure Trust Console 825. In this example Container 860d, running on Edge Compute 835, can be securely restarted using function (B), which represents the secure boot or container reload mechanism. This restart is initiated by the Boot Controller (BC), which is co-located with the Attestation Controller (AC) in the Cloud Secure Trust Console 825. The AC evaluates integrity using attestation data (A) from TEEs and behavioral telemetry from the external Monitor 830, which runs in a standard unsecure cloud environment 870a. If compromise is detected, AC triggers BC, which then executes the secure reload process. This end-to-end response is shown by arrow 898 in the diagram. The behavioral telemetry can detect various events that enable behavioral policy triggers.

The MADTF can inject credentials, including short-lived credentials for added security, for integrating services, transports, or agents which do not directly support the MADTF. The legacy services may use other credentials or certificates for security and access control in their data flows. Container 860c, running within the Distributed Credential Rotation node 815, implements both the datacentric MADTF transport function (D) for credential delivery and the credential rotation function (R) for short-lived ephemeral credentials. Container 860c delivers 888 credentials to proxy container 858 hosted along with user application container 865b in REE 855c of Remote Edge Device 810. Container 858 contains a proxy (P) which can inject short-lived credentials into the data flow 889 originating from user container 865b and delivered to Cloud-based LLM 820, which operates in a separate unsecure cloud environment 870b. The credentials are securely delivered 888 to the proxy container 858 by the datacentric (D) MADTF which establishes the NHI (N) and can apply access controls as specified in the Trust Rules. Alternatively (not shown), the proxy and MADTF interface together with the user application could be in a single container. This flow enables application container 865b to operate securely with dynamically rotated credentials without directly participating in MADTF transport (D) or trust enforcement. The use of credential injection can extend beyond LLM 820 to other services and agents including databases, monitors, and web servers as well as secure interconnects such as TLS, mTLS and VPN, which can have certificates managed and delivered with appropriate access controls provide by the MADTF and Trust Rules.

All MADTF-secured containers use cryptographic identity to sign and validate requests and responses, and can apply the Gating function (G) to control permitted data flows. Arrow 887 shows secure container-to-container messaging between container 860a in 855a and container 860b in 855b using MADTF transport (D).

Also shown is container 865a, a non-secure container located in 855b that does not participate in any MADTF trust flows. It is intentionally included to illustrate that untrusted or legacy containers may coexist with secure MADTF containers within the same physical system, such as the robot/sensor gateways 805. Although it lacks a policy enforcement mechanism (e.g., full cryptographic identity and gating), container 865a still benefits from MADTF's integrity architecture: its runtime environment can be monitored via attestation (A) and it can be subject to reboot or removal via boot control (B) under policy enforcement by the Trust Console.

The MADTF architecture supports secure and decentralized access across multiple trust domains and service tiers. For example, Edge Compute 835 directly queries the Cloud Secure LLM 840 over MADTF link 897, using MADTF certificates and locally enforced Trust Rules rather than relying on orchestration from the Cloud Secure Trust Console 825. In parallel, Remote Edge Device 810 accesses the Cloud-based LLM 820 over arrow 889, relying on dynamic short-lived credentials distributed by the local Credential Rotation node 815. Notably, the credential rotation function (R) is hosted in the decentralized 815 component, not in the Cloud Secure Trust Console 825, reinforcing the resilience and flexibility of MADTF infrastructure.

Additionally, the Cloud Secure LLM 840 accesses the Cloud Secure Database 845 via cloud-to-cloud link 896, retrieving sensitive contextual data for inference. This access is governed by datacentric MADTF transport (D) and constrained by locally enforced Trust Rules, demonstrating how MADTF enables secure, policy-bound data retrieval without centralized mediation. These interactions highlight MADTF's ability to enforce strong identity and policy at the edge, in the cloud, and across trusted services. In the MADTF architecture, identity mechanisms are paired with the datacentric transport function (D) to ensure that all communications are cryptographically attributable. For hardware-based entities such as edge devices and gateways, this is achieved using a local non-human identity (N), typically anchored in a TPM or other secure enclave. In contrast, cloud-based MADTF services rely on Cloud NHI (CN), which serves a parallel role by managing keys and identity through cloud-native services such as Azure Key Vault, AWS Key Management Service (KMS), or equivalent systems. Both (N) and (CN) provide the foundational cryptographic identity required to enable secure publication, policy enforcement, and trust validation across distributed agents.

The Cloud Secure Trust Console 825 serves as the central policy and trust coordination authority within the MADTF system. It hosts the Attestation Controller (AC), Boot Controller (BC), and credential rotation services (R), as well as a secure logging subsystem that records signed publications, certificate changes, and detected anomalies for forensic and regulatory purposes. Logging data may be stored using encrypted MADTF publications for enhanced security and provenance. Human users 110 authenticate to the system via identity and access management (I) mechanisms-such as MFA-and access the Trust Console through a human-in-the-loop interface 891. The human identity is verified through IAM (I), and that trust is transferred to the system via the Administrator Controller 880, which operates under a non-human identity (N) established by a cryptographic key pair and certificate issued within the MADTF framework. In cloud deployments, including that of the Cloud Secure Trust Console 825 accessed by the Administrator Controller 880, a corresponding Cloud NHI (CN) component—positioned outside the Cloud TEE boundary 875a-c—may serve as the secure identity anchor. This (CN) function can be implemented using managed cloud services such as Azure Managed Identity or AWS IAM Roles for Service Accounts, enabling the Cloud Secure Trust Console 825 to participate in MADTF-authenticated communication using cloud-native identity credentials. Similar (CN) mechanisms may also be used to establish non-human identity for the Cloud Secure LLM 840 and Cloud Secure Database 845, enabling these components to authenticate and participate in MADTF-governed data exchanges within the secure cloud.

From Administrator Controller 880 interface, administrators may review trust policies, approve certificate requests, inspect audit logs, and manage Trust Rules governing access across the distributed MADTF environment. The Cloud Secure Trust Console 825 may also initiate cloud-to-cloud access (e.g., arrow 892) to third-party services such as the external Monitor 830, using time-limited credentials securely rotated under policy. These interactions, while external to MADTF, are fully auditable and governed by Trust Rules, and all actions are cryptographically signed and logged to ensure provenance and tamper-evident traceability.

The MADTF framework supports a range of secure transport and communication methods beyond internet protocol (IP) networks. Communication between distributed or mobile agents may occur over multicast radio 885, including protocols such as WiFi6 and LoRa. These transports are supported by secure protocol stacks such as IPv6 and datacentric MADTF (D) networking, with TEE-hosted Validator (V) functions used to verify identities and enforce policy on inbound or outbound publications.

In some cases credentials, tokens, or certificates can be distributed over the MADTF while the data transport can be provided by conventional technologies, such as TLS, mTLS and VPN. In this way legacy services can be accessed using standard interfaces while adding a trust overlay through credential distribution and rotation provided by the MADTF and controlled by the Trust Rules. These credentials may be inserted into legacy services datastreams using proxies including the ability to securely rotate ephemeral credentials with distribution and access controls provided by the MADTF trust overlay.

### Example Use Cases

Agentic systems, particularly when structured as MAS, consist of autonomous software entities that act semi-independently to perform tasks, gather or process information, and interact with other agents or services. These agents may represent AI models, microservices, data filters, event handlers, or human-facing interfaces. MAS architectures enable complex, distributed tasks to be decomposed into coordinated workflows, with agents specializing in different roles and reasoning across different modalities. Agents may collaborate, compete, or train one another using architectures such as Generative Adversarial Networks (GANs), reinforcement learners, or retrieval-augmented generation systems. This structure supports scalability, modularity, robustness, and real- time adaptability-traits that are increasingly vital for modern software systems and infrastructure.

The MADTF framework enhances MAS by introducing cryptographic identity, secure messaging, and programmable trust enforcement. Each agent in a MADTF-enabled system can prove its role, origin, and authorization to act, enabling robust access control, delegation, and traceable operation. By combining MAS coordination with MADTF's verifiable infrastructure, a wide range of high-value application areas become feasible, particularly where trust, auditability, and cross-domain interaction are required. Application domains include but are not limited to cybersecurity, defense systems, healthcare, finance, education, industrial operations, telecommunications, enterprise automation, generative AI, and open-source intelligence analysis.

In cybersecurity and threat intelligence, MADTF and MAS can coordinate autonomous monitoring, threat classification, and mitigation across distributed enterprise systems. Agents can ingest logs, detect anomalies, identify vulnerabilities, and generate incident reports with cryptographic attribution. MAS structures support adversarial simulations, red-blue teaming, and attacker behavior modeling using GANs and LLM-based adversarial agents. MADTF ensures that each agent's contribution is authenticated and policy-conformant, enabling high-confidence threat intelligence, security operations center (SOC) automation, and secure threat sharing across organizational boundaries.

In defense and tactical systems, MADTF and MAS provide secure agent orchestration for autonomous platforms, sensor networks, and mission coordination frameworks. MAS enables swarming behaviors, dynamic targeting, GPS-denied navigation, appropriations analysis, direction finding, and adversarial response planning through reinforcement learning and simulated agents. MADTF secures the communications and access between these agents, enforces role-based authority even in disconnected environments, and ensures lawful command attribution through verifiable trust chains, enabling cross-service or allied integration while preserving operational security. Military applications include logistics optimization, real-time battlefield coordination, and weapon system integration.

In industrial operations and edge AI environments, MADTF and MAS enable distributed coordination of smart sensors, drones, robotic systems, and predictive maintenance workflows. Robotic Operating System ROS and ROS 2 can benefit from a secure publish-subscribe architecture with access control provided by MADTF. MAS agents manage local inference, fault detection, digital twin synchronization, and safety-critical control tasks. These systems extend to infrastructure inspection, mineral processing optimization, oil and gas reservoir exploration, and semiconductor layout planning. MADTF ensures that even in unreliable or intermittent networks, each message and control action can be authenticated, time-bounded, and logged for regulatory or forensic purposes. Agent roles and access to high-risk systems are enforced through verifiable certificates and trust rules.

In enterprise automation and digital workflows, MADTF and MAS can automate procurement pipelines, document processing, code generation, and compliance workflows. Agents can retrieve pricing data, analyze contracts, manage software licenses, summarize reports, or auto-generate technical documentation using internal LLMs and verification agents. MAS coordination enables assisted code development, legacy code modernization, quality assurance, and the digitization of financial records. MADTF secures the communication between these agents, ensures only authorized models or services are called, and enables high-value workflows to operate autonomously without compromising auditability or confidentiality.

In healthcare and clinical operations, MADTF and MAS can coordinate agents performing electronic health records (HER) analysis, claims review, clinical trial monitoring, diagnostic suggestion, and regulatory compliance. Autonomous agents can extract clinical insights, encode medical records, simulate datasets for federated research, or serve as claims assistants supporting payers and providers. MADTF enforces HIPAA-compliant access control, ensures provenance of outputs, and enables cross-institution collaboration while preventing data leakage or unauthorized processing. Applications also include medical coding automation, patient summarization, and population-level data analytics. MADTF integrated with GUI automation tools such as Selinium or PyAutoGUI facilitates secure agent interactions with legacy data portals when API access is not available.

In finance and risk management, MADTF and MAS can support fraud detection, market surveillance, underwriting, algorithmic trading, and financial reporting. Distributed agents can correlate signals across accounts, perform real-time compliance checks, generate summaries of financial disclosures, simulate synthetic financial datasets, or assist with regulatory filings. MAS architectures also enable credit scoring, claims automation, financial assistant tools, and insurance risk assessment. Through MADTF, each agent interaction is bound to its identity and trust level, enabling secure delegation, output verification, and tamper-proof audit trails across banking, insurance, and trading infrastructures.

In intelligence analysis and policy research, MADTF and MAS can synthesize open-source intelligence, legislative documents, operational field data, and historical archives. Agents can be assigned to scrape, summarize, cross-compare, and validate information sources within classification or jurisdictional boundaries. MAS is well-suited for defense policy research, automated budget and appropriation reviews, and multi-source briefing generation. MADTF ensures that each aggregation step is authorized, attributable, and traceable, enabling structured intelligence gathering and collaborative assessment across agencies or domains without compromising confidentiality.

In telecommunications and network operations, MADTF and MAS enable optimization of 5G/6G infrastructure, including network slicing, routing control, spectrum allocation, and interference mitigation. MAS agents coordinate across base stations, satellites, and mobile edge compute nodes, optimizing performance in real time. MAS also supports adaptive network configuration, onboarding of new devices, and the management of software-defined networks. MADTF provides each network agent with cryptographic identity and scoped authorization, enabling secure orchestration of services across federated operators, cloud platforms, and national borders. MADTF trust overlay can provide credential distribution to complex networks of secure connections including certificate distribution such as using X.509 certificates for mTLS, TLS and VPN interconnections. A wide range of tokens and credentials can be distributed and rotated with the MADTF for interconnections as well as access to services and SaaS systems. The trust overlay provides added security through secure consistent credential delivery and allows for the application of access controls. MAS frameworks can also support smart grid efficiency optimization where telecom and energy systems converge.

In generative media, personal assistants, and consumer-facing AI, MADTF and MAS ensure provenance, attribution, and safety across AI-generated content, adaptive marketing, non-player character (NPC) behavior, and personalized shopping or learning experiences. MAS agents can interact with asset libraries, licensing databases, user preferences, and narrative constraints to generate compliant, tailored output including video synthesis, virtual customer support, or dynamic product recommendations. Applications extend to tutoring agents, knowledge assistants, and on-device personalization. MADTF ensures these outputs are cryptographically signed, policy-conformant, and revocable, if necessary, enabling responsible and transparent deployment of generative and conversational systems.

### Computing Systems

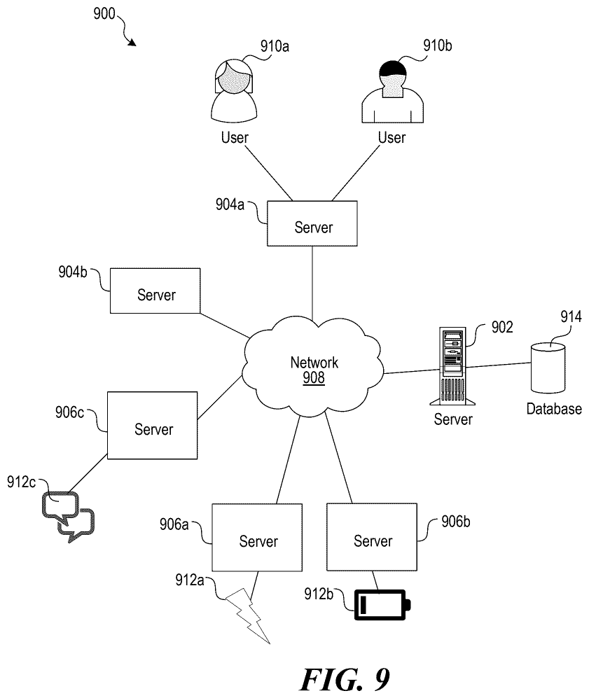

FIG. 9 is a network diagram illustrating a representative computing environment 900 in which a secure orchestration system, including one or more aspects of an MADTF, operates, according to some arrangements. Although not required, aspects of the system are described in the general context of computer-executable instructions, such as routines executed by a general-purpose computer, a personal computer, a server, or other computing system. The system can also be embodied in a special-purpose computer or data processor that is specifically programmed, configured, or constructed to perform one or more of the computer-executable instructions explained in detail herein. Indeed, the terms “computer” and “computing device,” as used generally herein, refer to devices that have a processor and non-transitory memory, like any of the above devices, as well as any data processor or any device capable of communicating with a network. Data processors include programmable general-purpose or special-purpose microprocessors, programmable controllers, application-specific integrated circuits (ASICs), programming logic devices (PLDs), or the like, or a combination of such devices. Computer-executable instructions may be stored in memory, such as random-access memory (RAM), read-only memory (ROM), flash memory, or the like, or a combination of such components.

Computer-executable instructions may also be stored in one or more storage devices, such as magnetic or optical-based disks, flash memory devices, or any other type of non-volatile storage medium or non-transitory medium for data. Computer-executable instructions may include one or more program modules, which include routines, programs, objects, components, data structures, and so on that perform particular tasks or implement particular abstract data types.

Aspects of the system can also be practiced in distributed computing environments, where tasks or modules are performed by remote processing devices, which are linked through a communications network, such as a Local Area Network (LAN), Wide Area Network (WAN), or the Internet. In a distributed computing environment, program modules or subroutines may be located in both local and remote memory storage devices. Aspects of the system described herein may be stored or distributed on tangible, non-transitory, computer-readable media, including magnetic and optically readable and removable computer discs, stored in firmware in chips (e.g., EEPROM chips). Alternatively, aspects of the system may be distributed electronically over the Internet or over other networks (including wireless networks). Those skilled in the relevant art will recognize that portions of the system may reside on a server computer while corresponding portions reside on a client computer.

The environment 900 includes server computers 902, 904a and 904b, and 906a-c (“servers”), which communicate with each other through a network 908. The network 908 can be, for example, a LAN or WAN, and can include wired and/or wireless network elements. In some embodiments, and as described herein, the network 908 is the Internet or some other combination of other public and/or private network.

Servers 902, servers 904a and 904b, and/or servers 906a-c operate one or more aspects, alone and/or in combination, of a secure orchestration system (such as an MADTF), which enables resources of an infrastructure system to securely communicate with users associated with the infrastructure system (e.g., an associated LLM or ML model, modules, or agents).

For example, servers 902 can be associated with or managed by an infrastructure provider (e.g., an energy infrastructure provider), and the secure orchestration system can be used to manage communication between resources, agents (e.g., trust agents, RAG agents, LLM agents, or other components), or devices deployed by the infrastructure provider (e.g., energy generation resources and energy storage resources) and users associated with the infrastructure (e.g., the infrastructure provider, resource vendors, resource technicians, home and commercial customers, etc.). Servers 902 can be associated with databases 914, which can store resource data, agent data, device data, infrastructure data, routing data, and so forth.

The servers 904a-c are computing devices operated by or otherwise associated with entities corresponding to different users of an infrastructure system. As used herein, an entity can refer to any organization, business, enterprise, residence, etc., that may communicate with resources within the infrastructure system. Examples of entities include the infrastructure provider, resource vendors, resource technicians, and customers of the infrastructure provider. Furthermore, each entity can be associated with one or more users 910a-c. For example, the infrastructure provider can have a user 910a corresponding to a particular engineer associated with the infrastructure provider and a user 910b corresponding to a particular system administrator associated with the infrastructure provider. As described further herein, the particular users 910a-c, as well as the roles with which they are associated (e.g., engineer, system administrator, etc.) can be represented by entities within the secure orchestration system. As described further herein, each entity (whether an organization, an individual user, or a role) can be associated with a name defined in an NDN hierarchical namespace. Although servers 904a and 904b are illustrated in FIG. 9, it will be appreciated that any arbitrary large number of servers can be found in the infrastructure systems.

The servers 906a-c are computing devices operated by or otherwise associated with entities corresponding to different resources 912a-c (e.g., agents, resources, or modules) within the infrastructure system. As used herein, a resource can refer to a distributed energy resource (DER), a networked electrical power generation load control and storage resource (NEPGLSR), or other infrastructure resource. For example, the server 906a can be associated with a power generation resource 912a, such as a solar array, a wind farm, or a nuclear power plant. As a further example, the server 906b can be associated with a power storage resource 912b, such as battery storage. In some implementations, the server 906c can be associated with a user interface 912c (e.g., associated with an LLM agent or a conversation agent that is able to provide answers to users' queries). As described further herein, each resource can be associated with a name defined in an NDN hierarchical namespace. Although only servers 906a, 906b, and/or 906c are illustrated in FIG. 9, it will be appreciated that any arbitrary large number of servers can be found in the infrastructure systems.

Although the environment 900 is described in the context of an infrastructure system (e.g., an electrical infrastructure system), it will be appreciated that one or more aspects of the secure orchestration system (such as an MADTF) can be utilized in an environment 900 used for other applications (e.g., other than infrastructure).

### Example Operations

In some aspects, the techniques described herein relate to a computing system configured to orchestrate identity-enforced, policy-controlled communication among a set of agents. The system includes a non-human identity (NHI) provisioning module configured to manage agent roles and cryptographic credentials including private keys and public certificates. The system can include or monitor a set of agents, wherein a first particular agent in the set of agents is associated, by the NHI provisioning module, with (i) a first agent role and (ii) a first cryptographic identity including a first private key and a first corresponding public certificate and a second particular agent in the set of agents is associated, by the NHI provisioning module, with (iii) a second agent role and (iv) a second cryptographic identity including a second private key and a second corresponding public certificate. The system includes a trust rules module configured to define and distribute role-based permissions as trust rules, wherein the trust module generates a first trust rule for the first agent based on the agent role. The system includes an information-centric networking (ICN) transport layer configured to disseminate named publications between agents in the set of agents using a messaging layer (e.g., mode of communication, protocol, set of devices and/or operations), such as the publish-subscribe mechanism, message queuing mechanism, or a combination thereof, mediated by a validator module. The system includes the validator module configured to verify, prior to accepting a particular publication associated with the first particular agent, that the particular publication is signed using the first private key of and conforms to the first trust rule.

In some aspects, the first trust rule is published as a signed versioned item distributed to a set of subscribing agents via a synchronized collection, and the set of agents includes, at least in part, the set of subscribing agents.

In some aspects, the first particular agent is associated with: (i) a containerized workload configured to execute in a real execution environment (REE), and (ii) a validator of the validator module; and the validator is configured to execute in a trusted execution environment (TEE) to perform one or more of: (iii) verify attestation data associated with a particular container for the containerized workload prior to accepting the particular publication, or (iv) validate the first corresponding public certificate prior to accepting the particular publication.

In some aspects, the trust rules define one or more of permissible topics, namespaces, or data flows; and the validator module is configured to block or enable publication forwarding by evaluating the trust rules.

In some aspects, a secure logging module is configured to capture and retrievably store one or more of validated publications, trust decisions, certificate changes, or audit events in a tamper-evident format.

In some aspects, the secure logging module is configured to archive logged records using an encrypted publication.

In some aspects, the NHI provisioning module includes a cloud-based identity provisioning mechanism for non-human agents and is configured to issue and retrievably store the agent roles, cryptographic credentials, or both to cloud-based services within a cloud environment.

In some aspects, the particular first agent is configured to store the first private key in a secure module, the secure module including one or both of a Trusted Platform Module (TPM) or embedded secure enclave.

In some aspects, the ICN transport layer is configured to disseminate the particular publication as a content-addressed publication.

In some aspects, a controller is configured to operate under a delegated NHI and perform operations including: (i) authenticate an administrator using an identity and access management mechanism, and (ii) enable an authenticated administrator to interact with the system.

In some aspects, the NHI provisioning module is configured to enable external services that lack ICN enforcement mechanisms to access publications via the cryptographic credentials. The cryptographic credentials include one or more of a time-limited token, a role-based certificate, an ephemeral session key, or another cryptographically verifiable access credential.

In some aspects, the NHI provisioning module is associated with a credential management service configured to inject credentials using a proxy and/or dynamically rotate the cryptographic credentials based on one or more of a trust rule update or a behavioral policy trigger.

In some aspects, the particular publication is associated with a named publication topic, and the validator module is configured to enforce rule-based message flow using named publication topic in connection with accepting the particular publication.

In some aspects, the particular publication is associated with metadata that enables trust-based filtering and validation by the second particular agent.

In some aspects, a trust relay agent is configured to enable Federated trust between a first domain and a second domain by validating cross-signed certificates that originate from external certificate authorities, wherein the first particular agent is associated with the first domain and the second particular agent is associated with the second domain.

In some aspects, the validator module is configured to operate on multicast wireless transports using an ICN publish-subscribe mechanism.

In some aspects, the techniques described herein relate to a computer-implemented method for orchestrating trust-controlled interaction among agents in a multi-agent computing system, the method including: assigning a first cryptographic identity to a first particular agent and a second cryptographic identity to a second particular agent; generating and publishing a set of trust rules configured to define role-based communication permissions for at least the second particular agent; receiving a publication signed by the second particular agent; validating the publication using a public certificate corresponding to the second cryptographic identity; and accepting or rejecting the publication based on its conformance with one or more applicable trust rules from the set of trust rules, wherein accepting the publication includes making the publication accessible or actionable by the first particular agent.

In some aspects, the techniques described herein include verifying attestation data associated with a container that executes in connection with operating the second particular agent prior to accepting the publication.

In some aspects, the techniques described herein include relaying the publication through a Federated trust relay that enforces cross-domain trust policies, wherein the first particular agent is associated with a first domain and a second particular agent is associated with a second domain.

In some aspects, the techniques described herein include, upon determining that a particular service lacks a policy enforcement mechanism, issuing temporary credentials to a the particular service, wherein the temporary credentials are constrained by one or more of a time, a scope, or an operational context.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” and/or any variant thereof means any connection or coupling, either direct or indirect, between two or more elements; the coupling and/or connection between the elements can be physical, logical, and/or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively.

The above detailed description of implementations of the system is not intended to be exhaustive or to limit the system to the precise form disclosed above. While specific implementations of, and examples for, the system are described above for illustrative purposes, various equivalent modifications are possible within the scope of the system, as those skilled in the relevant art will recognize. For example, some network elements are described herein as performing certain functions. Those functions could be performed by other elements in the same or differing networks, which could reduce the number of network elements. Alternatively, or additionally, network elements performing those functions could be replaced by two or more elements to perform portions of those functions. In addition, while processes, message/data flows, and/or blocks are presented in a given order, alternative implementations may perform routines having blocks, or employ systems having blocks, in a different order, and some processes or blocks may be deleted, moved, added, subdivided, combined, and/or modified to provide alternative or subcombinations. Each of these processes, message/data flows, and/or blocks may be implemented in a variety of different ways. Also, while processes and/or blocks are at times shown as being performed in series, these processes or blocks may instead be performed in parallel, and/or may be performed at different times. Further, any specific numbers noted herein are only examples: alternative implementations may employ differing values and/or ranges. Those skilled in the art will also appreciate that the actual implementation of a database may take a variety of forms, and the terms “database” and “library” are used herein in the generic sense to refer to any data structure that enables data to be stored and accessed, such as tables, linked lists, arrays, etc.

The teachings of the methods and systems provided herein can be applied to other systems, not necessarily the system described above. The elements, blocks, and acts of the various implementations described above can be combined to provide further implementations.

Any patents and applications and other references noted above, including any that may be listed in accompanying filing papers, are incorporated herein by reference. To the extent any materials incorporated herein by reference conflict with the present disclosure, the present disclosure controls. Aspects of the technology can be modified, if necessary, to employ the systems, functions, and concepts of the various references described above to provide yet further implementations of the technology.

These and other changes can be made to the invention in light of the above Detailed Description. While the above description describes certain implementations of the technology, and describes the best mode contemplated, no matter how detailed the above appears in text, the technology can be practiced in many ways. Details of the system may vary considerably in its implementation details while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the invention to the specific implementations disclosed in the specification, unless the above Detailed Description section explicitly defines such terms.

I/we claim:

1. A computing system configured to orchestrate identity-enforced, policy-controlled communication among a set of agents, the computing system comprising:
a non-human identity (NHI) provisioning module configured to manage agent roles and cryptographic credentials including private keys and public certificates;
the set of agents, wherein a first particular agent in the set of agents is associated, by the NHI provisioning module, with (i) a first agent role and (ii) a first cryptographic identity comprising a first private key and a first corresponding public certificate and a second particular agent in the set of agents is associated, by the NHI provisioning module, with (iii) a second agent role and (iv) a second cryptographic identity comprising a second private key and a second corresponding public certificate;
a trust rules module configured to define and distribute role-based permissions as trust rules, wherein the trust rules module generates a first trust rule for the first particular agent based on the first agent role;
an information-centric networking (ICN) transport layer configured to disseminate named publications between agents in the set of agents using a messaging layer mediated by a validator module, wherein the messaging layer includes a publish-subscribe layer, a message queuing layer, or a combination thereof; and
the validator module configured to verify, prior to accepting a particular publication associated with the first particular agent, that the particular publication is signed using the first private key of and conforms to the first trust rule.

2. The computing system of claim 1,
wherein the first trust rule is published as a signed versioned item distributed to a set of agents via the messaging layer by using at least one of: (i) a synchronized collection to a set of subscribing agents or (ii) a queue-based delivery to a set of receiving agents, and wherein the set of agents includes, at least in part, the set of subscribing agents or the set of receiving agents.

3. The computing system of claim 1,
wherein the first particular agent is associated with: (i) a containerized workload configured to execute in a real execution environment (REE), and (ii) a validator of the validator module; and
wherein the validator is configured to execute in a trusted execution environment (TEE) to perform one or more of:
(iii) verify attestation data associated with a particular container for the containerized workload prior to accepting the particular publication, or
(iv) validate the first corresponding public certificate prior to accepting the particular publication.

4. The computing system of claim 1,
wherein trust rules define one or more of permissible topics, namespaces, or data flows; and
wherein the validator module is configured to block or enable publication forwarding by evaluating the trust rules.

5. The computing system of claim 1, further comprising:
a secure logging module configured to capture and retrievably store one or more of validated publications, trust decisions, certificate changes, or audit events in a tamper-evident format.

6. The computing system of claim 5,
wherein the secure logging module is configured to archive logged records using an encrypted publication.

7. The computing system of claim 1,
wherein the NHI provisioning module includes a cloud-based identity provisioning mechanism for non-human agents and is configured to issue and retrievably store the agent roles, cryptographic credentials, or both to cloud-based services within a cloud environment.

8. The computing system of claim 1,
wherein the first particular agent is configured to store the first private key in a secure module, the secure module including one or both of a Trusted Platform Module (TPM) or embedded secure enclave.

9. The computing system of claim 1,
wherein the ICN transport layer is configured to disseminate the particular publication as a content-addressed publication.

10. The computing system of claim 1, the computing system further comprising:
a controller configured to operate under a delegated NHI and perform operations comprising:
(i) authenticate an administrator using an identity and access management mechanism, and
(ii) enable an authenticated administrator to interact with the system.

11. The computing system of claim 1,
wherein the NHI provisioning module is configured to enable external services that lack ICN enforcement mechanisms to access publications via the cryptographic credentials; and
wherein the cryptographic credentials comprise one or more of a time-limited token, a role-based certificate, an ephemeral session key, or another cryptographically verifiable access credential.

12. The computing system of claim 11,
wherein NHI provisioning module is associated with a credential management service configured to provide at least one of inject credentials using a proxy; and dynamically rotate the cryptographic credentials based on one or more of a trust rule update or a behavioral policy trigger.

13. The computing system of claim 1,
wherein the particular publication is associated with a named publication topic, and wherein the validator module is configured to enforce rule-based message flow using named publication topic in connection with accepting the particular publication.

14. The computing system of claim 1,
wherein the particular publication is associated with metadata that enables trust- based filtering and validation by the second particular agent.

15. The computing system of claim 1, the computing system further comprising:
a trust relay agent configured to enable Federated trust between a first domain and a second domain by validating cross-signed certificates that originate from external certificate authorities,
wherein the first particular agent is associated with the first domain and the second particular agent is associated with the second domain.

16. The system of claim 1,
wherein the messaging layer includes the publish-subscribe layer and the message queuing layer; and
wherein the validator module is configured to operate on multicast wireless transports using an ICN publish-subscribe mechanism.

17. A computer-implemented method for orchestrating trust-controlled interaction among agents in a multi-agent computing system, the method comprising:
assigning a first cryptographic identity to a first particular agent and a second cryptographic identity to a second particular agent;
generating and publishing a set of trust rules configured to define role-based communication permissions for at least the second particular agent;
receiving a publication signed by the second particular agent;
validating the publication using a public certificate corresponding to the second cryptographic identity; and
accepting or rejecting the publication based on its conformance with one or more applicable trust rules from the set of trust rules, wherein accepting the publication comprises making the publication accessible or actionable by the first particular agent.

18. The method of claim 17, the method further comprising:
verifying attestation data associated with a container that executes in connection with operating the second particular agent prior to accepting the publication.

19. The method of claim 17, the method further comprising:
relaying the publication through a Federated trust relay that enforces cross-domain trust policies,
wherein the first particular agent is associated with a first domain and a second particular agent is associated with a second domain.

20. The method of claim 17, the method further comprising:
upon determining that a particular service lacks a policy enforcement mechanism, issuing temporary credentials to a the particular service,
wherein the temporary credentials are constrained by one or more of a time, a scope, or an operational context.
